(19) United States
(12) Patent Application Publication
(10) Pub. No.: US 2013/0147333 A1
(43) Pub. Date: Jun. 13, 2013

(54) INFORMATION TERMINAL APPARATUS AND HINGE UNIT

(71) Applicant: FUJITSU LIMITED, Kawasaki-shi (JP)

(72) Inventors: Hisamitsu Takagi, Kawasaki (JP); Hitoshi Shiroyama, Kawasaki (JP)

(73) Assignee: FUJITSU LIMITED, Kawasaki-shi (JP)

(21) Appl. No.: 13/759,352

(22) Filed: Feb. 5, 2013

Related U.S. Application Data
(62) Division of application No. 12/688,237, filed on Jan. 15, 2010.

(30) Foreign Application Priority Data
Jan. 30, 2009 (JP) 2009-020882

(51) Int. Cl. H04M 1/02; F16H 21/40

(52) U.S. Cl. CPC H04M 1/0237; F16H 21/40
USPC 312/319.2; 74/55

(57) ABSTRACT

An information terminal apparatus includes a base plate fixed on the surface of a first housing, having a guide opening formed in the base plate and extended in a direction parallel to the surface of the base plate; and a swing plate including a shaft portion protruding perpendicularly to the surface of the swing plate and engaging with the guide opening, the swing plate being rotatable about the shaft portion with respect to the base plate. The information terminal apparatus further includes a cam mechanism having a cam groove provided on one of the swing plate and the base plate, and a cam pin provided on the other of the swing plate and the base plate, the cam pin engaging with the cam groove, the swing plate being rotatable while sliding in the direction with respect to the base plate when external force is applied to the swing plate.

### CROSS-REFERENCE TO RELATED APPLICATION

This application is a divisional of U.S. application Ser. No. 12/688,237 filed on Jan. 15, 2010 which is based upon and claims the benefit of priority from the prior Japanese application No. 2009-020882, filed Jan. 30, 2009, the entire contents of which are incorporated herein by reference.

### FIELD

The embodiments discussed herein are related to an information terminal apparatus and a hinge unit.

### BACKGROUND

In recent years, an information terminal apparatus such as a mobile phone set has a number of functions such as a data transmitting and receiving function which allows web site viewing, transmission and reception of electronic mails, receiving television broadcasting (one segment broadcasting), or the like, a camera function, a recording and reproducing function, a video viewing function, a personal information management function, a game playing function in addition to a voice call function. Such an information terminal apparatus has a vertically long shape with a reduced width for the convenience of the voice call function that is frequently used in general.

Also, recently, in contrast to a tendency to increase the size of a liquid crystal display or a display screen employing an organic EL or the like, such information terminal apparatus has been small-sized and reduced in weight in order to improve the portability. For example, a sliding type mobile phone set including a housing having a display screen and a housing having an operating unit which are slidably provided so as to be small in size, or a folding type mobile phone set provided with a hinge between two housings which are folded to be small in size are currently on the market.

These types of mobile phone sets have such functions as the electronic mail transmission and reception function, the TV broadcasting receiving function, and the video viewing function, for which the display screen in a laterally long shape is desirable for the sake of convenience and visibility. Therefore, in recent years, a technique is proposed in which a housing having a display screen of a sliding type mobile phone set is rotated with respect to a housing having an operating unit thereof, causing the display screen to be placed horizontally and in a T-shape as a whole to achieve a good balance in terms of the center of gravity (for example, see Japanese Laid-open Patent Publication No. 2007-49294, Japanese Laid-open Patent Publication No. 2007-71283, Japanese Laid-open Patent Publication No. 2005-109971, Japanese Laid-open Patent Publication No. 2008-92264, and Japanese Laid-open Patent Publication No. 2008-103989).

However, in Japanese Laid-open Patent Publication No. 2007-49294 described above for example, in order to change the entire shape of a mobile terminal into the T-shape, one of the housings is rotated by 90° at a predetermined position between a first mode in which the two housings are closed by being overlapped with each other to a second mode in which one of the housings is slid to allow a user to talk on the phone. Therefore, the user tries to feel that the housings are set at the predetermined position via a tactile “click” sensation with finger tips in order to rotate the one of the housings. It is relatively difficult for the user to feel the tactile “click” sensation with finger tips, which may reduce operability of the mobile terminal.

Also, in Japanese Laid-open Patent Publication No. 2007-71283 or Japanese Laid-open Patent Publication No. 2005-109971 described above, one of the housings is rotated by 90° from a state in which the two housings are slid to be in an entirely extended state as in the second mode described above, causing the entire mobile phone set to be in an L-shape. Then, from this state, one of the housings is slid with respect to the other housing to achieve the T-shape as a whole. In this manner, in Japanese Laid-open Patent Publication No. 2007-71283 or Japanese Laid-open Patent Publication No. 2005-109971, the user rotates and slides the housings to change the shape of the mobile phone set into the T-shape.

In other words, in each of Japanese Laid-open Patent Publication No. 2007-71283 and Japanese Laid-open Patent Publication No. 2005-109971 (and Japanese Laid-open Patent Publication No. 2007-49294), two-step operation are to be performed from the state in which the two housings are overlapped with each other (the first mode described above) or the state in which the user talks on the phone (the second mode described above) to the state in which the entire mobile phone set is in the T-shape. Therefore, in view of operability, improvement of the two-step operation is desired.

Also, when using the information terminal apparatus configured to allow the user to rotate the housing, the user holds the other housing which is not to be rotated. In other words, if the housing hits the hand while rotating, the rotation of the housing is hindered. However, this point is not studied in any of Japanese Laid-open Patent Publication No. 2007-49294, Japanese Laid-open Patent Publication No. 2007-71283, Japanese Laid-open Patent Publication No. 2005-109971, Japanese Laid-open Patent Publication No. 2008-92264, and Japanese Laid-open Patent Publication No. 2008-103989.

### SUMMARY

According to an aspect of the invention, an information terminal apparatus includes a first housing including an input operation unit; a second housing including a display unit; a base plate fixed on the surface of the first housing, having a guide opening formed in the base plate and extended in a direction parallel to the surface of the base plate; a swing plate including a shaft portion protruding perpendicularly to the surface of the swing plate and engaging with the guide opening, the swing plate being rotatable about the shaft portion with respect to the base plate, the second housing being mounted over the opposite surface of the swing plate opposite to the shaft portion; and a cam mechanism having a cam groove provided on one of the swing plate and the base plate, and a cam pin provided on the other of the swing plate and the base plate, the cam pin engaging with the cam groove, the swing plate being rotatable while sliding in the direction with respect to the base plate when external force is applied to the swing plate so as to rotate the swing plate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a drawing illustrating a first state of a mobile phone set according to a first embodiment, and FIG. 1B is a drawing illustrating a second state of the mobile phone set according to the first embodiment;

FIG. 2 is a drawing illustrating a third state of the mobile phone set according to the first embodiment;

FIG. 3A is an exploded drawing of the mobile phone set according to the first embodiment, and FIG. 3B is a cross-sectional view taken along the line A-A in FIG. 3A;

FIG. 4A is a perspective view illustrating a state in which a base plate and a swing plate are viewed from the +Z side, and FIG. 4B is a perspective view illustrating a state in which the swing plate is viewed from the −Z side;

FIG. 5A is a drawing illustrating a state in which the base plate and the swing plate are assembled, and FIG. 5B and FIG. 5C are drawings illustrating states in which the base plate and the swing plate are assembled when viewed from the −Z side;

FIGS. 6A to 6D are drawings (part 1) for explaining a rotation of the swing plate in association with a movement in a Y-axis direction;

FIGS. 7A to 7D are drawings (part 2) for explaining a rotation of the swing plate in association with a movement in the Y-axis direction;

FIGS. 8A to 8C are drawings (part 1) for explaining a movement of the slide plate;

FIGS. 9A and 9B are drawings (part 2) for explaining a movement of the slide plate;

FIG. 10 is a drawing (part 3) for explaining a movement of the slide plate;

FIGS. 11A and 11B are drawings for explaining the configurations, arrangements and actions of a spring mechanism (part 1);

FIGS. 12A to 12C are drawings illustrating a configuration of the spring mechanism;

FIGS. 13A and 13B are drawings for explaining the configurations, arrangements and actions of the spring mechanism (part 2);

FIGS. 14A and 14B are drawings for explaining the configurations, arrangements and actions of the spring mechanism (part 3);

FIGS. 15A and 15B are drawings for explaining an action of a projecting portion;

FIGS. 16A and 16B are drawings illustrating an advantage of the first embodiment (part 1);

FIG. 17 is a drawing illustrating an advantage of the first embodiment (part 2);

FIG. 18 is a drawing illustrating projecting portions according to a modification;

FIGS. 19A and 19B are drawings for explaining an action or the like of the projecting portions (part 1);

FIGS. 20A and 20B are drawings for explaining an action or the like of the projecting portions (part 2);

FIGS. 21A and 21B are drawings illustrating another example of the projecting portions;

FIG. 22 is a drawing illustrating a modification of the first embodiment;

FIG. 23 is an exploded perspective view of a mobile phone set according to a second embodiment;

FIGS. 24A and 24B are drawings illustrating a method of assembling a swing plate and a base plate to a slide plate (part 1);

FIGS. 25A to 25E are drawings illustrating a method of assembling the swing plate and the base plate to the slide plate (part 2);

FIG. 26A is an exploded drawing illustrating a part of a mobile phone set according to a third embodiment, and FIG. 26B and FIG. 26C are drawings illustrating a rotation preventing mechanism;

FIGS. 27A and 27B are drawings illustrating an action of the rotation preventing mechanism (part 1);

FIGS. 28A to 28C are drawings illustrating an action of the rotation preventing mechanism (part 2);

FIGS. 29A and 29B are drawings illustrating an action of the rotation preventing mechanism (part 3);

FIGS. 30A and 30B are drawings illustrating the swing plate according to a fourth embodiment;

FIGS. 31A and 31B are drawings illustrating the base plate according to the fourth embodiment;

FIGS. 32A to 32C are drawings illustrating a rotating motion of the swing plate according to the fourth embodiment;

FIGS. 33A and 33B are drawings illustrating an example of a bendable mobile phone set; and

FIGS. 34A to 34C are drawings illustrating an action of the mobile phone set illustrated in FIGS. 33A and 33B.

### DESCRIPTION OF EMBODIMENTS

### First Embodiment

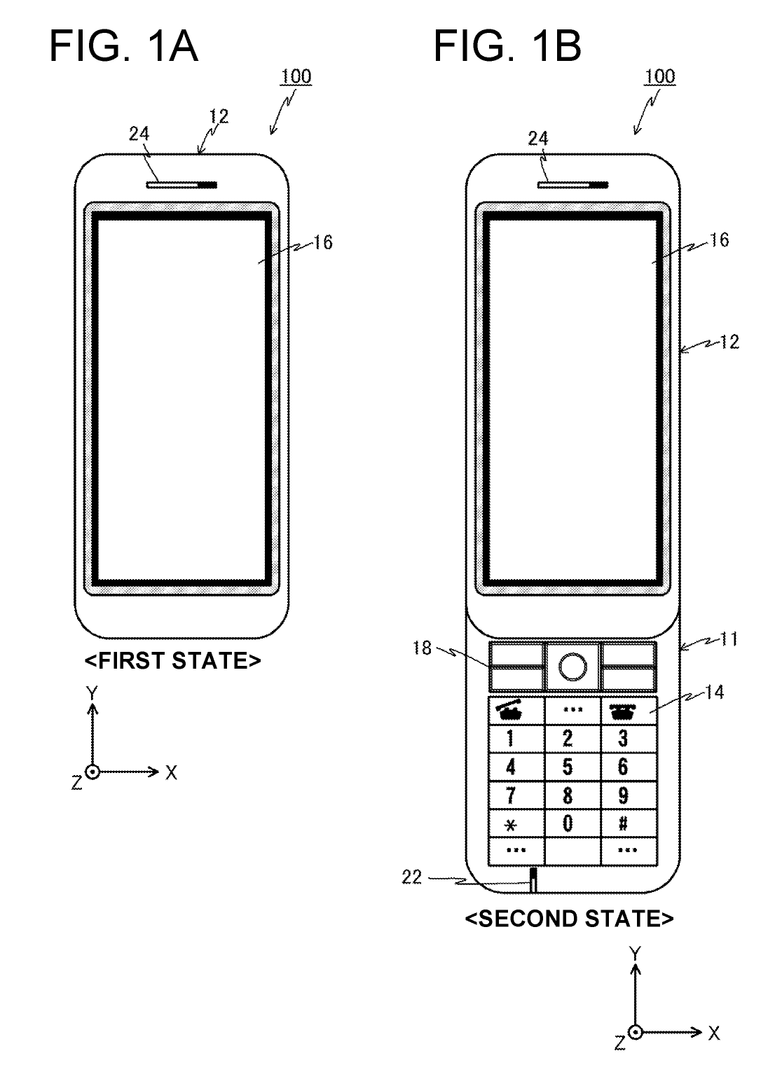

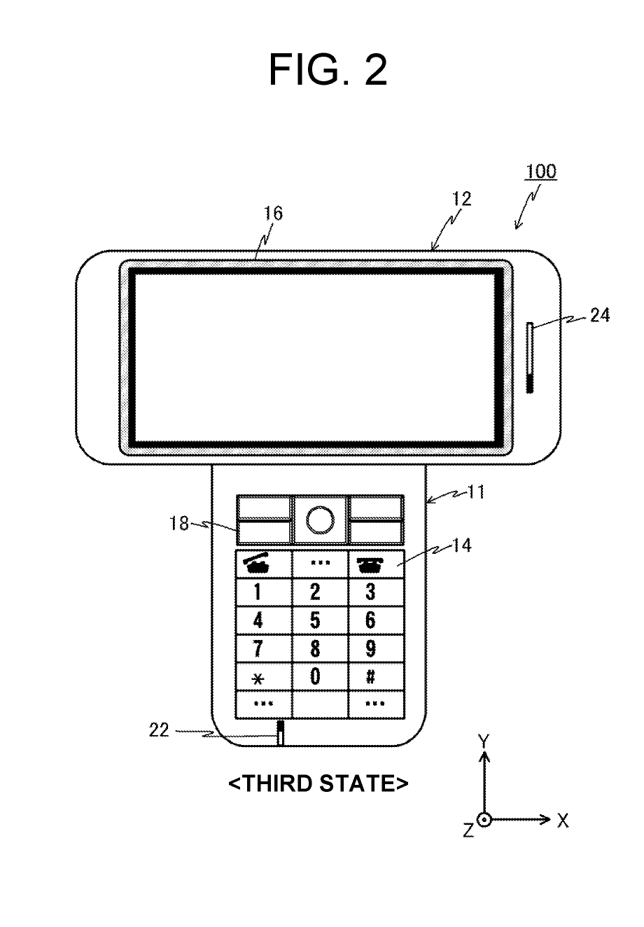

Referring now to FIG. 1A to FIG. 17, an information terminal apparatus according to a first embodiment will be described in detail. FIGS. 1A, 1B and FIG. 2 are plan views of a mobile phone set 100 according to the first embodiment. In the following description, for the convenience of description, a longitudinal direction (vertical direction) of a display screen 16 as a display unit of the mobile phone set 100 in FIG. 1A is defined as a Y-axis direction, a widthwise direction (lateral direction) of the same is defined as an X-axis direction, and a direction orthogonal to the display screen 16 (thickness direction) is defined as a Z-axis direction for description.

The mobile phone set 100 is capable of being transformed among a first state as illustrated in FIG. 1A, a second state as illustrated in FIG. 1B, and a third state as illustrated in FIG. 2.

From among these states, the first state illustrated in FIG. 1A is a state in which a first housing 11 (not illustrated in FIG. 1A, see FIG. 1B) and a second housing 12 (a housing having the display screen 16) are overlapped with each other. In the first state, the entire length of the mobile phone set 100 in terms of the Y-axis direction (vertical direction) is minimized. Therefore, the mobile phone set 100 is set mainly to this first state when carrying the same, or when viewing simple information such as phone call history, or information on the Internet.

The second state in FIG. 1B is a state in which the second housing 12 is slid upward (in the +Y direction) from the first state (FIG. 1A) and the entire length of the mobile phone set 100 is maximized. In the second state, a state in which a first operating button 14 and a second operating button 18 as an operating unit of the first housing 11 are exposed. Therefore, when an operation using the operating buttons 14, 18 such as a phone call or creation of a sending mail or the like is performed, this second state is assumed.

The third state illustrated in FIG. 2 is a state in which the second housing 12 is rotated by 90° from the second state (FIG. 1B) with respect to the first housing 11. In this case, since the display screen 16 is horizontally long, this third state is assumed mainly when viewing the TV (one segment broadcasting), viewing videos, viewing information on the Internet or received mails, or playing games.

A detailed configuration of the mobile phone set 100 will be described below.

The mobile phone set 100 includes the first housing 11 having the first operating button 14 and the second operating button 18 and the second housing 12 having the display screen 16 as illustrated in FIG. 1B. A hinge unit, described later, is provided between the first housing 11 and the second housing 12.

The first housing 11 has a flat and substantially parallelepiped shape as illustrated in FIG. 1B. A voice transmitting unit 22 is provided on a −Y-side end of a front surface of the first housing 11 (a +Z-side surface). The voice transmitting unit 22 includes a microphone provided in the interior of the first housing 11. The first operating button 14 provided on the +Y side of the voice transmitting unit 22 includes a ten key, a voice call starting key, a voice call end key, and so on. The second operating button 18 provided on the +Y side of the first operating button 14 includes a direction key and shortcut keys, and so on.

The second housing 12 has a flat and substantially parallelepiped shape like the first housing 11. A microphone unit 24 is provided in the vicinity of the +Y side of the second housing 12. The microphone unit 24 includes a speaker provided in the interior of the second housing 12. The display screen 16 configured with a liquid crystal panel, an organic EL display or the like is provided at a substantially center portion of a +Z-side surface of the second housing 12. The display screen 16 may have a function as a touch panel in order to enable the operation on the display screen 16 in the state illustrated in FIG. 1A.

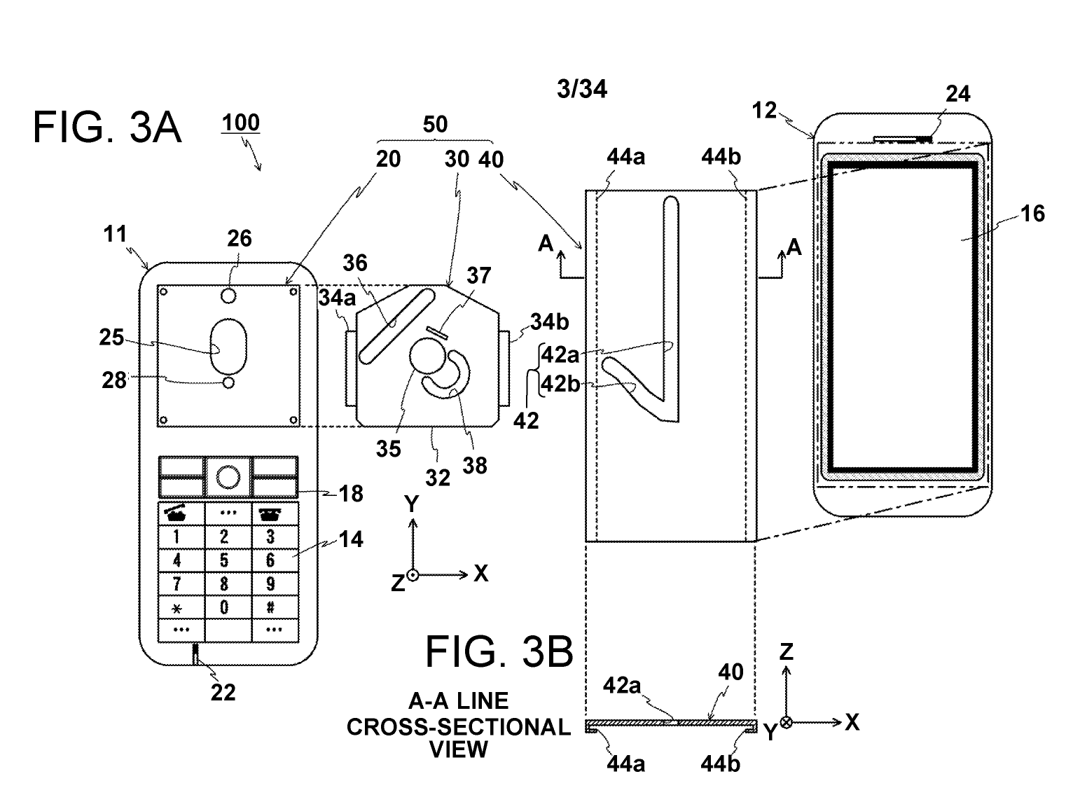

FIG. 3A is an exploded view of the mobile phone set 100. As illustrated in FIG. 3A, a hinge unit 50 is provided between the first housing 11 and the second housing 12. The hinge unit 50 includes a base plate 20, a swing plate 30, and a slide plate 40.

The base plate 20 is formed of a substantially rectangular plate member, and is fixed to the first housing 11 on a +Y-side end of a +Z-side surface with a screw or the like. An elongated guide opening 25 is formed at a substantially center of the base plate 20 so as to penetrate therethrough. A clearance is defined between a portion of a −Z-side surface of the base plate 20 in the vicinity of the guide opening 25 and the +Z-side surface of the first housing 11.

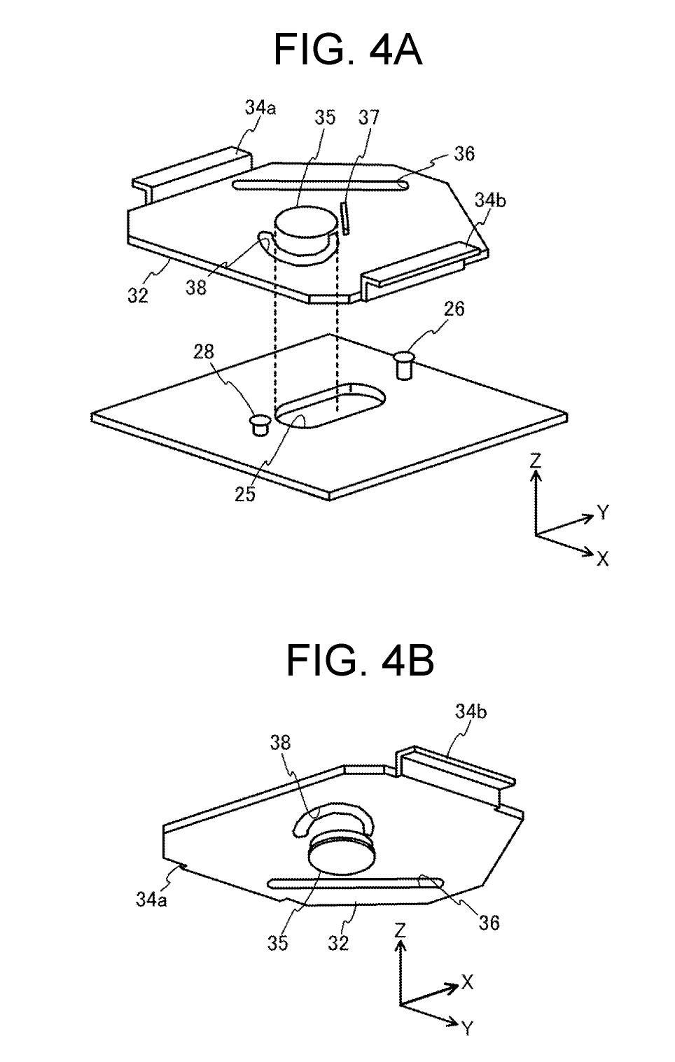

Also, A first cam pin 26 and a second cam pin 28 are formed so as to project upright therefrom on a +Z-side surface of the base plate 20. The first cam pin 26 and the second cam pin 28 are located at a center portion of the base plate 20 in terms of the X-axis direction. The first cam pin 26 is set to be thicker than the second cam pin 28, and the length of the first cam pin 26 in the Z-axis direction is set to be longer than the length of the second cam pin 28 in the Z-axis direction as illustrated in a perspective view in FIG. 4A. The first cam pin 26 and the second cam pin 28 each include a flange portion at an upper end thereof, and the flange portions prevent the respective cam pins 26, 28 from coming apart from first and second cam grooves 36, 38. In the drawings used in the following description, the flange portions may be omitted for the convenience of illustration.

Referring back to FIGS. 3A and 3B, the swing plate 30 includes a body portion 32 having a square shape notched at four corners, and sliding leg portions 34a, 34b having an L-shape in XZ cross section provided at an −X-side end and an +X-side end of the body portion 32 (see FIG. 4A). A shaft portion 35 is fixed to a substantially center portion of the body portion 32. The shaft portion 35 assumes a state of projecting in the −Z direction as is understood from FIG. 4B illustrating a state of viewing the swing plate 30 from the −Z side. Also, as illustrated in FIG. 4A, a projecting portion 37 is provided so as to project upright from the vicinity of the shaft portion 35 on a +Z-side surface of the body portion 32.

Also, the swing plate 30 is formed with a substantially linear first cam groove 36 extending in the direction intersecting the X-axis and the Y-axis and the substantially U-shaped second cam groove 38 in the vicinity of the shaft portion 35 of the body portion 32 so as to penetrate therethrough.

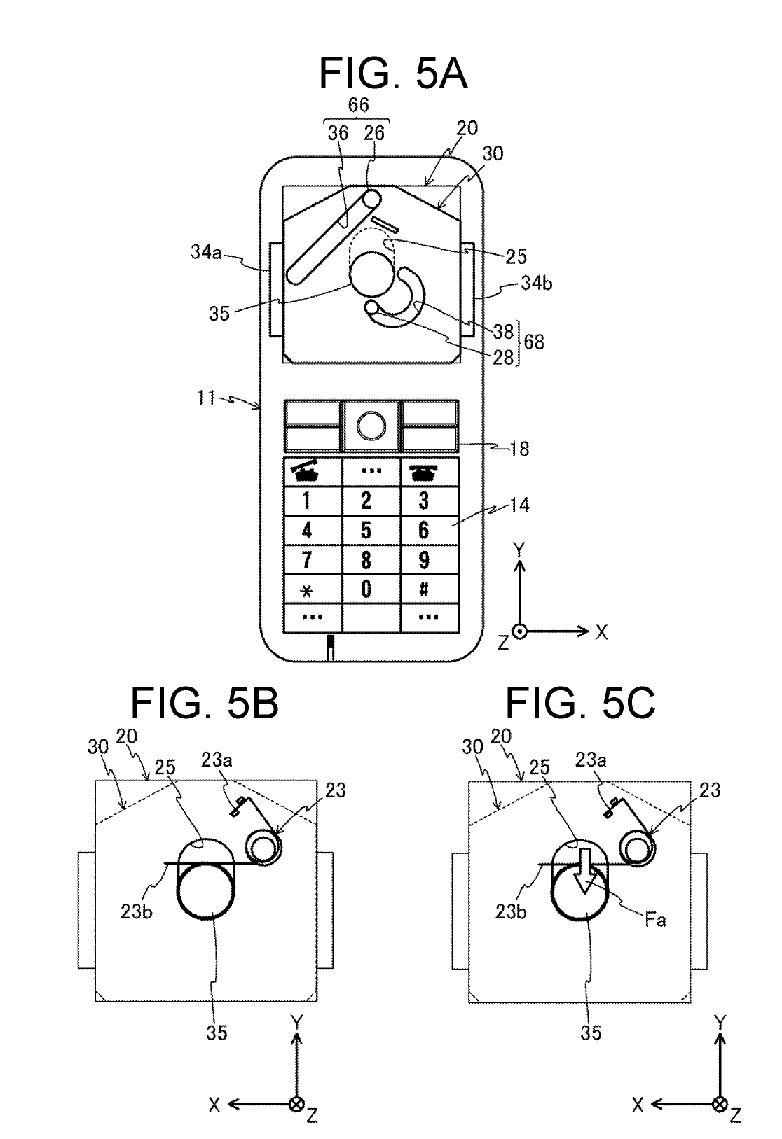

FIG. 5A illustrates a state in which the swing plate 30 is assembled to the base plate 20 in plan view. As illustrated in FIG. 5A, in a state in which the swing plate 30 is assembled to the base plate 20, the first cam pin 26 provided on the base plate 20 engages the first cam groove 36, and the second cam pin 28 engages the second cam groove 38 provided on the base plate 20. The shaft portion 35 of the swing plate 30 engages the guide opening 25 of the base plate 20. In this embodiment, the first cam pin 26 and the first cam groove 36 constitute a first cam mechanism 66, and the second cam pin 28 and the second cam groove 38 constitute a second cam mechanism 68.

Also, a torsion spring 23 as an urging member is provided on a back surface (−Z surface) of the base plate 20 as is understood from FIG. 5B illustrating the state in FIG. 5A viewed from the back surface side of the base plate 20 (−Z side). One end 23a of the torsion spring 23 is fixed to the base plate 20, and the other end 23b side is in contact with the shaft portion 35. The torsion spring 23 constantly applies an urging force Fa in the −Y direction to the shaft portion 35 as illustrated in FIG. 5C.

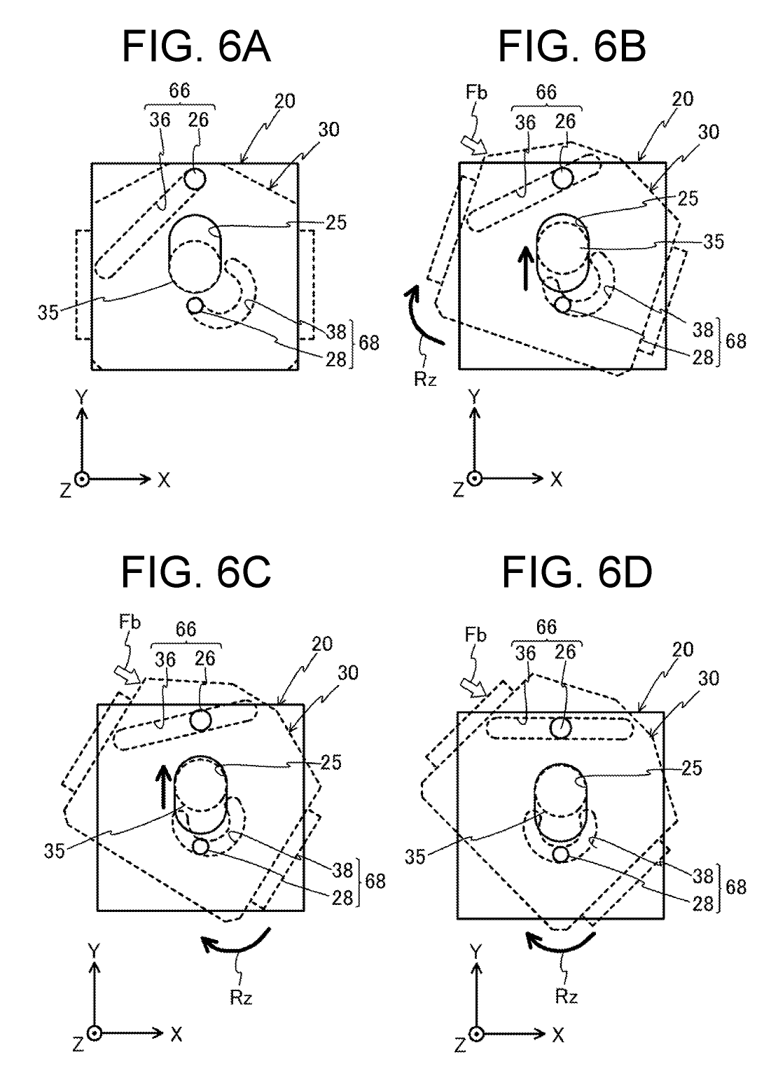

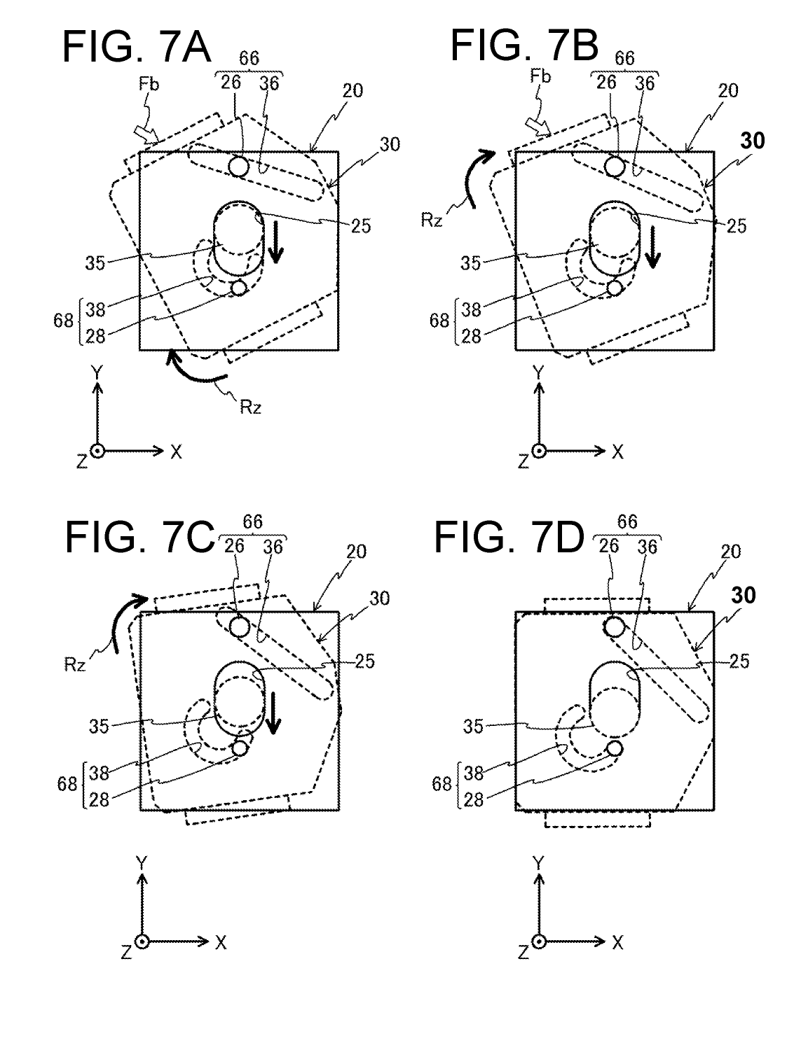

Subsequently, an action (movement) of the swing plate 30 with respect to the base plate 20 will be described on the basis of FIGS. 6A to 7D.

FIG. 6A illustrates a state of the base plate 20 (solid line) and the swing plate 30 (broken line) in a state before rotation (the mobile phone set 100 is in a second mode (FIG. 1B). In this state, the shaft portion 35 is positioned at a −Y-side end of the guide opening 25. When a force Fb in the direction of rotation (Rz direction) acts on the swing plate 30 as illustrated in FIG. 6B from the state in FIG. 6A, the swing plate 30 rotates in the Rz direction and is moved in the +Y direction. The movement of the swing plate 30 in the +Y direction is achieved by the shaft portion 35 sliding in the guide opening 25 while being guided by the first cam mechanism 66 and the second cam mechanism 68.

Then, the swing plate 30 moves in the +Y direction while rotating in the Rz direction through the state illustrated in FIG. 6C until it rotates by 45° as illustrated in FIG. 6D. In this manner, in a state illustrated in FIG. 6D in which the swing plate 30 is rotated by 45°, the shaft portion 35 is positioned at a +Y-side end of the guide opening 25. During the action from FIG. 6A to FIG. 6D, since the urging force Fa (the force in the −Y direction) from the torsion spring 23 acts on the shaft portion 35 (see FIG. 5C), the swing plate 30 slides in the +Y direction while receiving the urging force Fa.

Subsequently, when the angle of rotation exceeds 45° as illustrated in FIG. 7A, the swing plate 30 rotates in the Rz direction, and simultaneously, moves in the −Y direction. Then, when the swing plate 30 rotates by 90° as illustrated in FIG. 7D through the states illustrated in FIG. 7B and FIG. 7C, the shaft portion 35 is returned to the −Y-side end of the guide opening 25. FIG. 7D illustrates a state of the base plate 20 and the swing plate 30 when the mobile phone set 100 is in the third state (FIG. 2). The urging force Fa of the torsion spring 23 (the force in the −Y direction) acts on the shaft portion 35 also during the actions illustrated in FIG. 7A to FIG. 7D (see FIG. 5C). Therefore, during the states illustrated from FIG. 7A to FIG. 7D, the swing plate 30 slides smoothly in the −Y direction by the action of the urging force Fa.

As described above, in this embodiment, the swing plate 30 is adapted to move in the +Y direction and the −Y direction with respect to the base plate 20 when the swing plate 30 is rotated with respect to the base plate 20.

When returning from the state illustrated in FIG. 7D to the state illustrated in FIG. 6A, actions in the order completely reverse from the actions described above are performed.

Returning back to FIG. 3A, the slide plate 40 is a rectangular-shaped plate member as a whole. The slide plate 40 is formed with a substantially L-shaped slide guide opening 42 as a guide portion so as to penetrate therethrough. The slide guide opening 42 includes a first opening portion 42a extending in the Y-axis direction, and a second opening portion 42b extending from a −Y-side end of the first opening portion 42a in the direction orthogonal to the X-axis and the Y-axis. An end of the second opening portion 42b on the opposite side from the first opening portion 42a is positioned at a substantially center portion in terms of the longitudinal direction (Y-axis direction) of the slide plate 40.

Also, the slide plate 40 is formed with a pair of slide guides 44a, 44b by being bent into an angular C-shape (U-shape) in cross section at an end on the −X side and an end on the −X side as illustrated in FIG. 3B, which is a cross-sectional view taken along the line A-A in FIG. 3A.

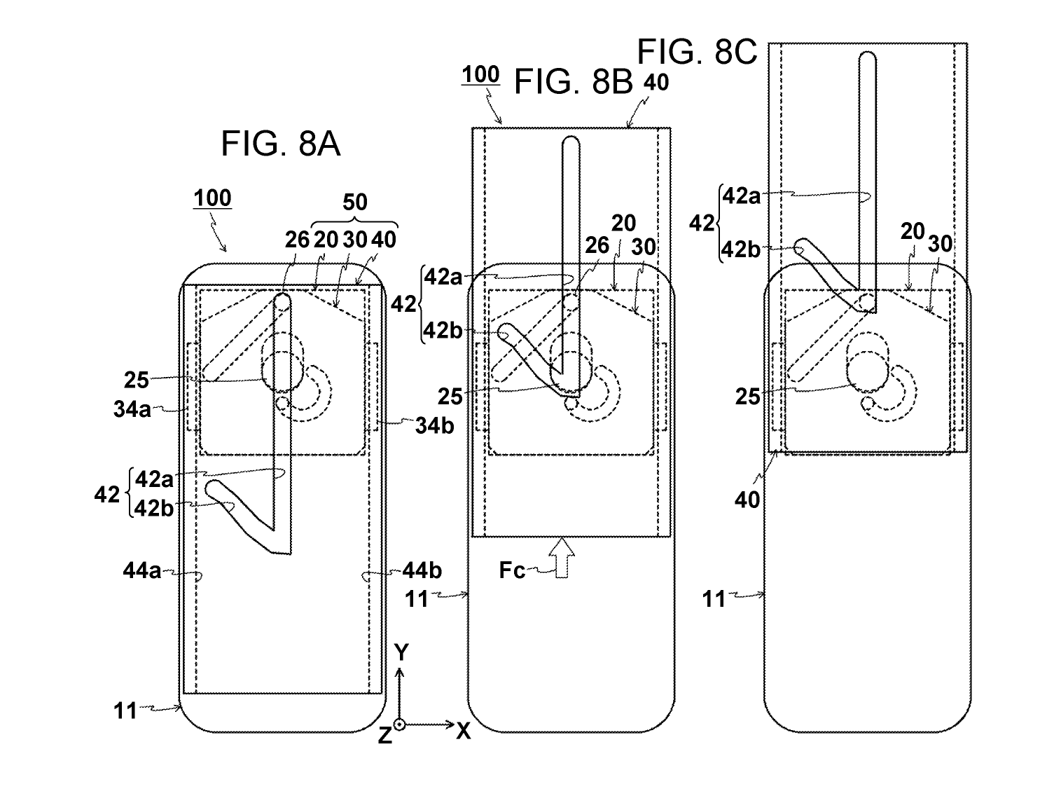

The slide plate 40 is slidably held with respect to the swing plate 30 as illustrated in FIG. 8A. Specifically, the slide plate 40 is held by the swing plate 30 in a state in which the slide guides 44a, 44b of the slide plate 40 engage the sliding leg portions 34a, 34b of the swing plate 30 respectively, and a distal end (the distal end on the +Z side) of the first cam pin 26 is inserted into the slide guide opening 42.

Subsequently, the action (movement) of the slide plate 40 will be described in detail on the basis of FIG. 8A to FIG. 10. In FIGS. 8A to 10, illustration of the second housing 12 is omitted.

FIG. 8A illustrates a case in which the mobile phone set 100 is in the first state (FIG. 1A). In the first state, the first cam pin 26 is positioned at a +Y-side end of the slide guide opening 42, and the slide plate 40 is adapted not to be able to move further on the −Y side.

In FIG. 8B, a state in which the slide plate 40 is moved in the +Y direction from the state illustrated in FIG. 8A by a force Fc in the +Y direction applied to the slide plate 40. In this state, the first cam pin 26 is positioned in the first opening portion 42a of the slide guide opening 42. Therefore, even though a force about the Z-axis acts on the slide plate 40, the slide plate 40 and the swing plate 30 engaging the slide plate 40 do not rotate because of the contact between the first cam pin 26 and the slide guide opening 42.

FIG. 8C illustrates a state in which the slide plate 40 is moved further in the +Y direction from the state illustrated in FIG. 8B (the second state (see FIG. 1B). In this state, the first cam pin 26 is positioned at a portion of the slide guide opening 42 where the first opening portion 42a and the second opening portion 42b intersect. In other words, the slide plate 40 does not move further in the +Y direction.

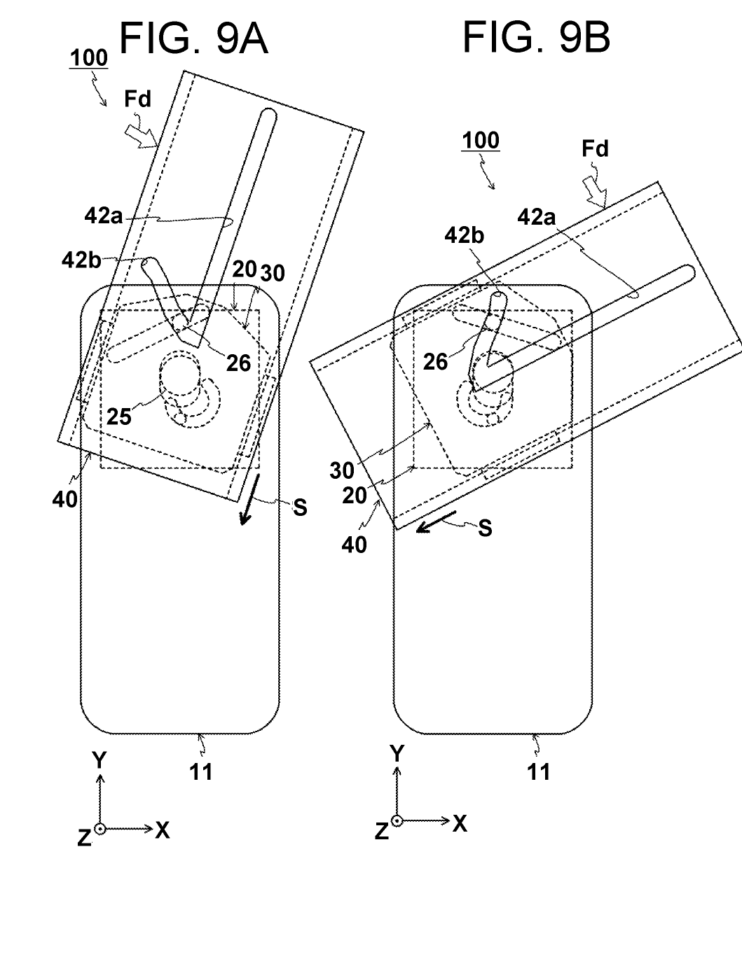

FIG. 9A illustrates a state in which a force Fd in the rotation direction about the Z-axis is applied to the slide plate 40 from the state illustrated in FIG. 8C. As illustrated in FIG. 9A, when the rotating force Fd acts on the slide plate 40, the slide plate 40 and the swing plate 30 start rotating. In this state, the swing plate 30 rotates while reciprocating in the +Y direction and the −Y direction as described in conjunction with FIG. 6A to FIG. 7D, while the slide plate 40 rotates while sliding in the direction indicated by an arrow S as illustrated in FIG. 9A and FIG. 9B by the second opening portion 42b lying along the first cam pin 26.

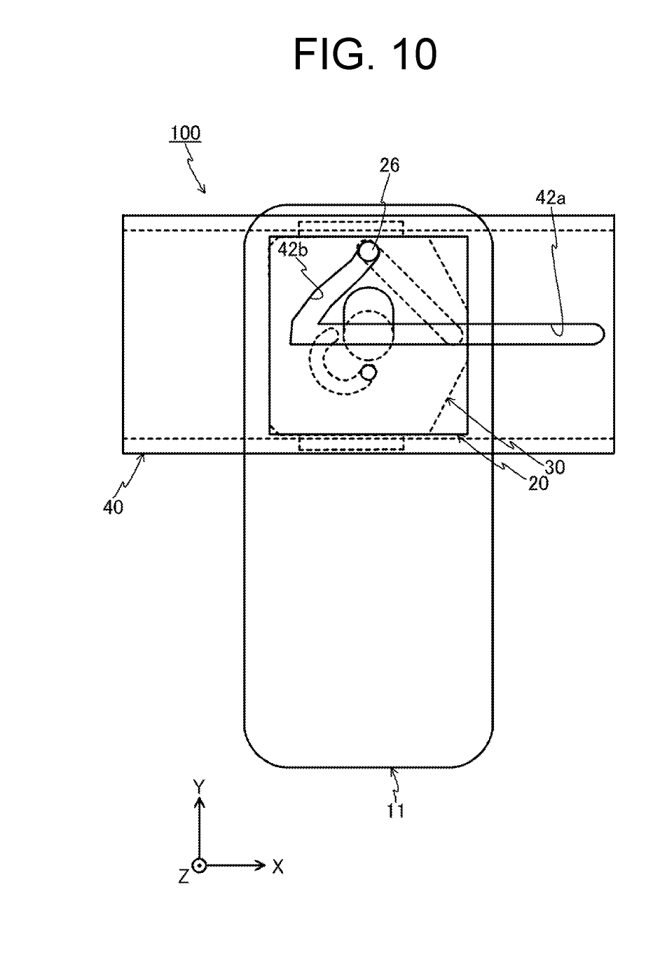

In this embodiment, through the actions described above, the slide plate 40 is seated at a position where it is rotated by 90° and a center portion of the first housing 11 in the widthwise direction (X-axis direction) substantially match a center portion of the slide plate 40 in the longitudinal direction (third state (see FIG. 2)) as illustrated in FIG. 10. The reason why the slide plate 40 is positioned at the position illustrated in FIG. 10 in the third state is that the first cam pin 26 is positioned at the center of the base plate 20 in terms of the X-axis direction, and the end of the second opening portion 42b on the opposite side from the first opening portion 42a is positioned at the center portion of the slide plate 40 in terms of the longitudinal direction.

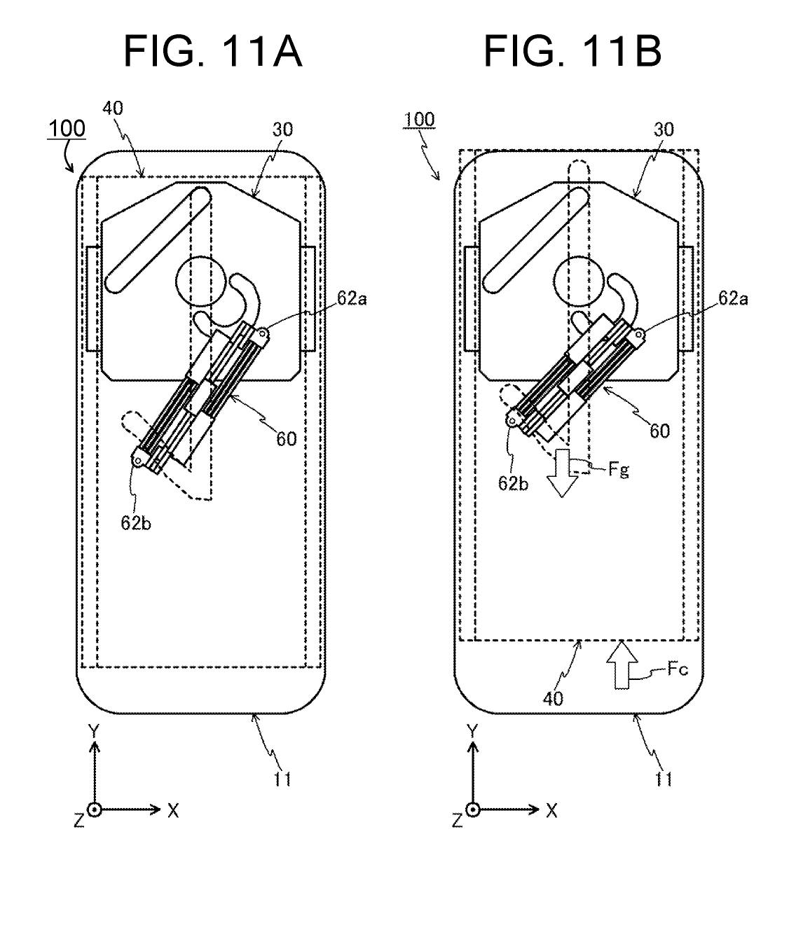

Incidentally, a spring mechanism 60 is provided between the swing plate 30 and the slide plate 40, actually as illustrated in FIG. 11A. The spring mechanism 60 includes two attachment members 62a, 62b. The attachment member 62a, which is one of these attachment members, is connected to a +Z surface of the swing plate 30, and the other attachment member 62b is connected to a −Z surface of the slide plate 40.

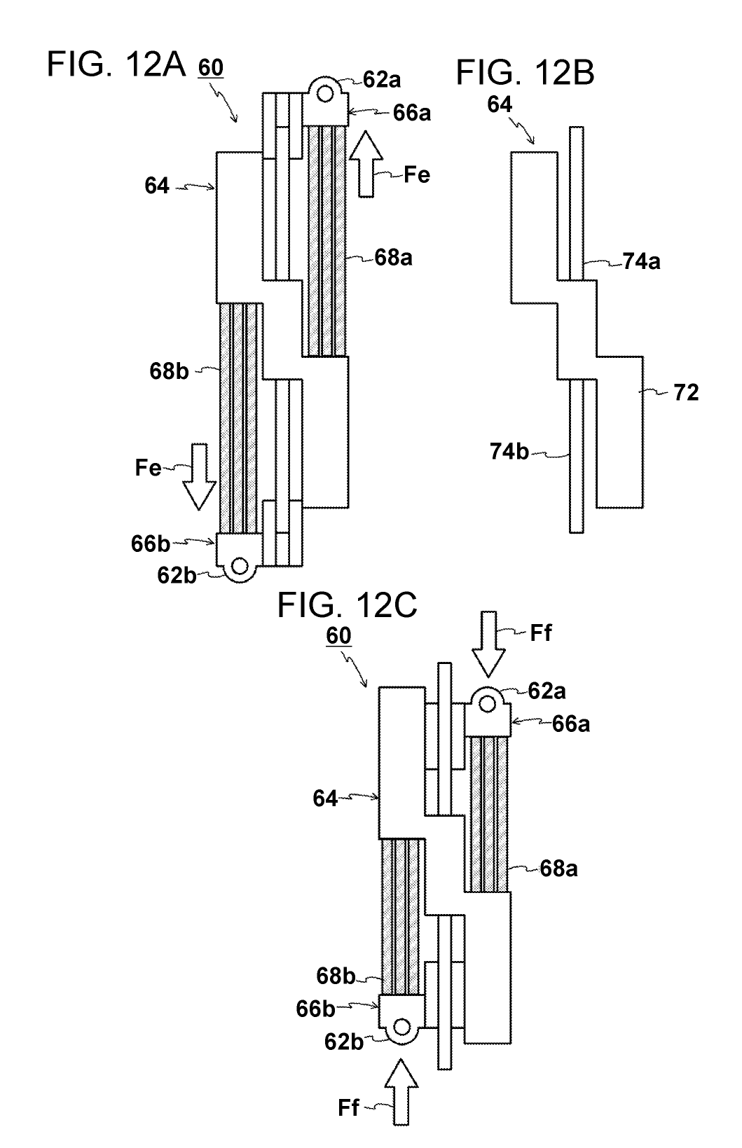

FIG. 12A is a drawing illustrating the spring mechanism 60 disassembled and enlarged in scale. As illustrated in FIG. 12A, the spring mechanism 60 includes a center member 64, a pair of moving portions 66a, 66b sliding with respect to the center member 64, and compression coil springs 68a, 68b provided between the center member 64 and the respective moving portions 66a, 66b.

The center member 64 includes a body 72, and sliding shafts 74a, 74b fixed to the body 72 as illustrated in FIG. 12B in a disassembled state. The moving portions 66a, 66b are slidably held by the sliding shafts 74a, 74b of the center member 64 as illustrated in FIG. 12A. The moving portion 66a from among the members described above is provided with the attachment member 62a described above, and the moving portion 66b is provided with the attachment member 62b. The compression coil springs 68a, 68b constantly apply an urging force (elastic force) Fe illustrated in FIG. 12A to the moving portions 66a, 66b.

In the spring mechanism 60 configured as described above, the entire length thereof is shortened by the action of a force (compressive force) Ff against the urging force Fe applied on the moving portion 66 as illustrated in FIG. 12C. When the force Ff does not act no longer, the state in FIG. 12A is restored by the urging force (elastic force) Fe.

Subsequently, the action (movement) of the spring mechanism 60 configured as described above in the mobile phone set 100 will be described on the basis of FIGS. 11A, 11B, FIGS. 13A, 13B, and FIGS. 14A, 14B.

FIG. 11A illustrates a state in which the slide plate 40 is positioned at an end in the −Y direction (first state). In the state illustrated in FIG. 11A, the entire length of the spring mechanism 60 is maximized (see FIG. 12A) is assumed. When the force Fc acts on the slide plate 40 as illustrated in FIG. 11B from this state, the slide plate 40 moves in the +Y direction upon receipt of the force Fc. In this case, the spring mechanism 60 is reduced in its entire length while being rotated about the attachment member 62a, so that a force Fg acts on the slide plate 40 by the elastic forces of the compression coil springs 68a, 68b. Therefore, in the state illustrated in FIG. 11B, when the user stops pressing the slide plate 40 in the +Y direction to avoid the force Fc to act thereon, the state illustrated in FIG. 11A is automatically restored.

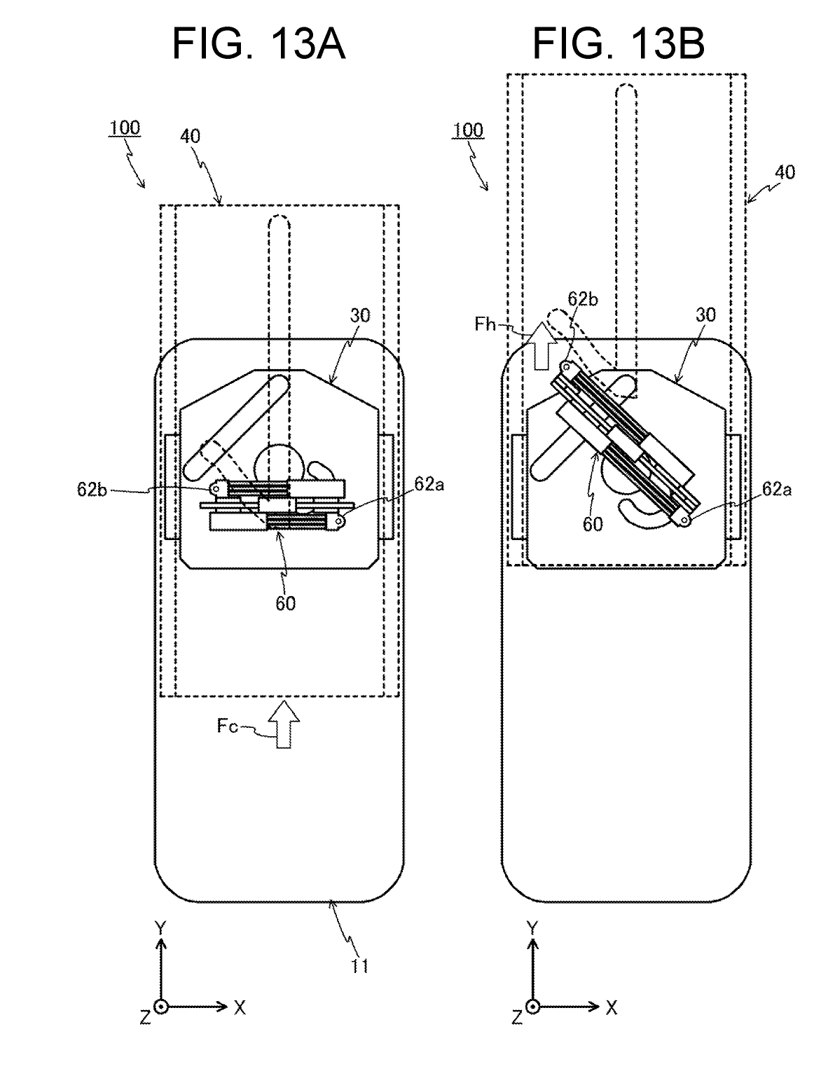

Also, when the force Fc is caused to act from the state illustrated in FIG. 11B, a state in which the longitudinal direction of the spring mechanism 60 matches the X-axis direction is assumed as illustrated in FIG. 13A. In this case, the spring mechanism 60 assumes a state in which the entire length is minimized as illustrated in FIG. 12C and, in this state, the spring mechanism 60 only generates a force in the X-axis direction, so that the force of the spring mechanism 60 in the Y-axis direction does not act on the slide plate 40. In contrast, when the force Fc is caused to act even the extent is little in the state illustrated in FIG. 13A, a force in the +Y direction (a force Fh illustrated in FIG. 13B) acts on the slide plate 40 by the elastic force of the spring mechanism 60, so that the slide plate 40 is moved automatically to a position illustrated in FIG. 13B even though the user does not apply the force.

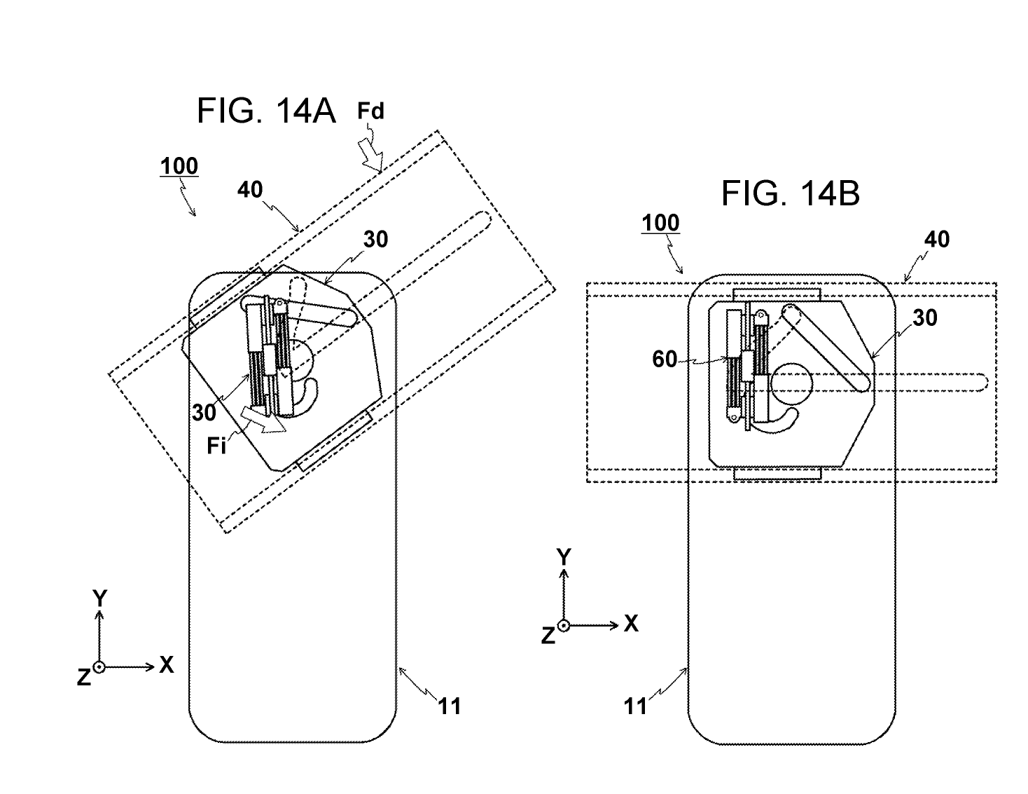

Also, when the rotating force Fd is applied to the slide plate 40 as illustrated in FIG. 14A from the state illustrated in FIG. 13B, the slide plate 40 and the swing plate 30 are rotated, and the spring mechanism 60 is shortened in the entire length while rotating as illustrated in FIG. 14A and FIG. 14B. In this case as well, a force Fi is applied to the slide plate 40 by the elastic force of the spring mechanism 60 in the course of rotation as illustrated in FIG. 14A, so that the state is returned automatically to the state illustrated in FIG. 13B when the user stops applying the force Fd in the course of the rotation as illustrated in FIG. 14A.

Subsequently, the action or the like of the projecting portion 37 (see FIG. 4A and so on) provided on the swing plate 30 described above will be described.

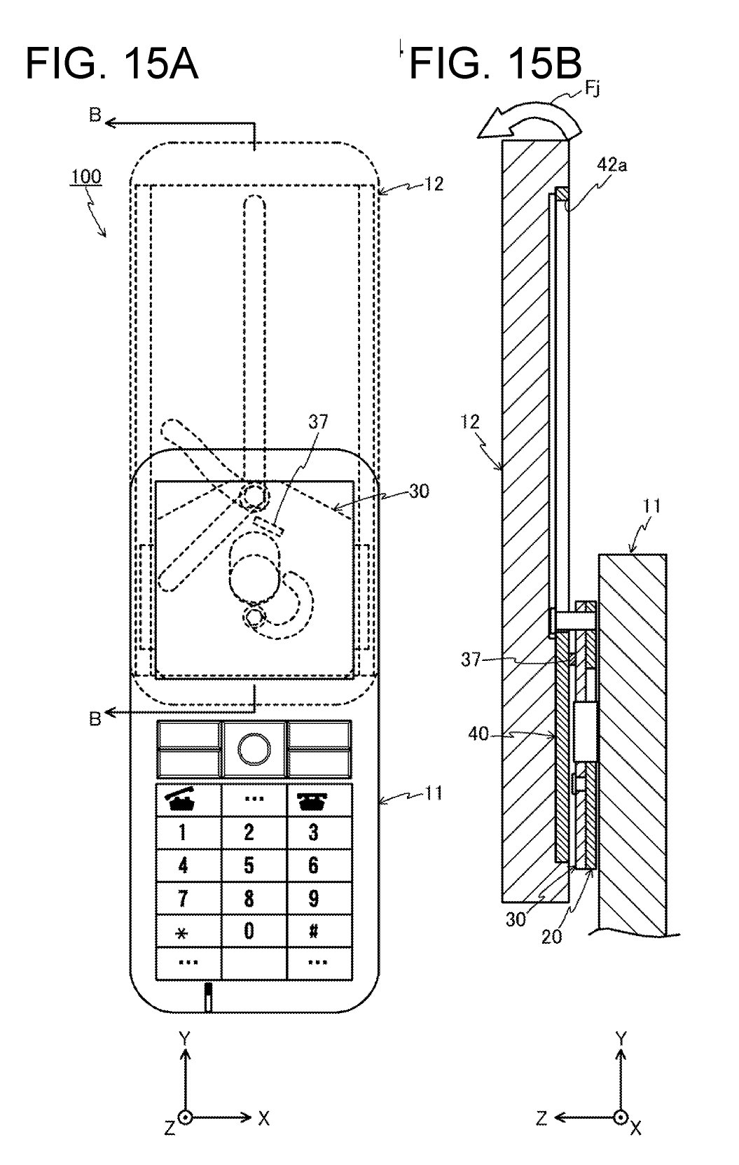

FIG. 15A illustrates a positional relationship between the projecting portion 37 and the slide plate 40 when the mobile phone set 100 is in the second state (FIG. 1B). Also, in FIG. 15B, a cross-sectional view taken along the line B-B in FIG. 15A is illustrated in an enlarged scale.

As is understood from these drawings, when the mobile phone set 100 is in the second state, a +Z end of the projecting portion 37 comes into contact with the −Z surface of the slide plate 40. Accordingly, even when a force Fj illustrated in FIG. 15B is applied to a +Y-side end of the second housing 12, the inclination of the second housing 12 with respect to the first housing 11 is restricted by the projecting portion 37, so that the amount of deformation can be reduced in comparison with the case where the projecting portion 37 is not provided. In this case, by limiting the amount of deformation within the limit of elasticity of the material of the second housing 12, the original state is restored without remaining the deformation in the second housing 12 even when the force Fj is applied.

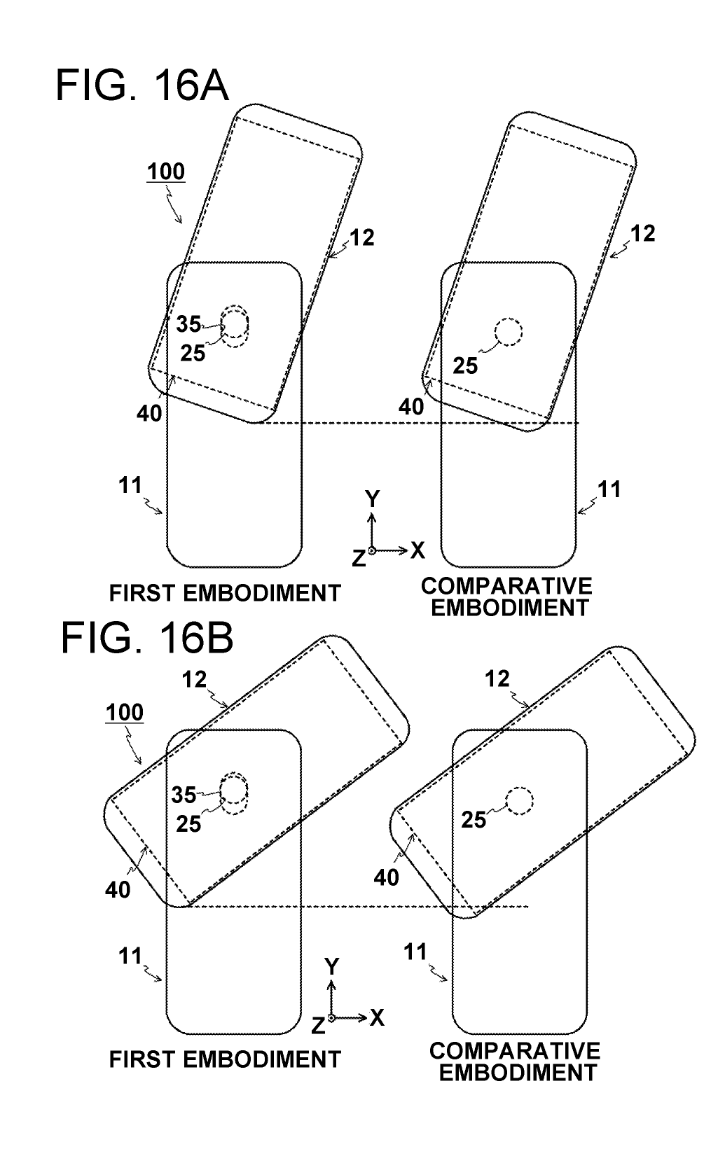

As described above in detail, according to the first embodiment, the shaft portion 35 of the swing plate 30 engages the guide opening 25 formed on the base plate 20 so as to extend in the Y-axis direction, and when the rotating force acts on the swing plate 30, the first and second cam mechanisms 66, 68 rotate about the Z-axis direction while causing the swing plate 30 to slide in the Y-axis direction with respect to the base plate 20, that is, while causing the shaft portion 35 to slide along the guide opening 25, so that a composite action including the rotation and the movement is achieved as the action of the swing plate 30 with respect to the base plate 20. In this embodiment, the swing plate 30 moves in the +Y direction after having started the rotation from the second state, and then the swing plate 30 moves in the −Y direction after having rotated by 45°, so that protrusion of the second housing 12 in the −Y side while the second housing 12 is rotated may be restrained in comparison with the case in which the shaft portion 35 does not move in the Y-axis direction (comparative example) as illustrated in FIG. 16A and FIG. 16B. Accordingly, the interference between the second housing 12 and the user's hand which holds the first housing 11 can be restrained, and hence the improvement of the operability is achieved.

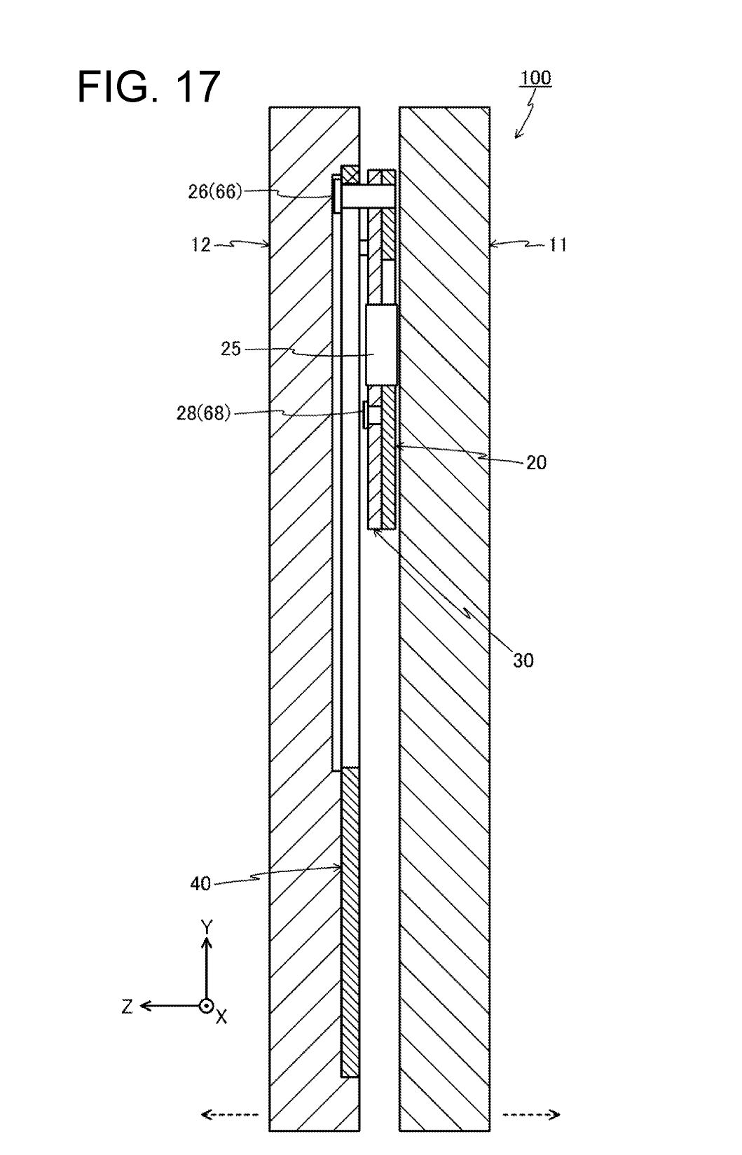

Also, in the first embodiment, the base plate 20 and the swing plate 30 engage with each other by the first cam mechanism 66 including the first cam pin 26 provided on the +Y side of the shaft portion 35 and the second cam mechanism 68 including the second cam pin 28 provided on the −Y side of the shaft portion 35 as illustrated in the cross-sectional view in FIG. 17. In this manner, in the first embodiment, the tight-contact state between the base plate 20 and the swing plate 30 can be stably maintained by providing the first and second cam mechanisms 66, 68 at a position opposing to each other with the intermediary of the shaft portion 35. Accordingly, since the separation between the base plate 20 and the swing plate 30 is restrained, occurrence of such event that the first housing 11 and the second housing 12 are separated as indicated by an arrow in a broken line due to the usage of the mobile phone set 100 for a long time can be restrained. Although a large clearance is defined between the first housing 11 and the second housing 12 for the convenience of illustration in FIG. 17, the clearance as large as that illustrated in FIG. 17 does not exist because the base plate 20 and the swing plate 30 are actually formed of thin plate members.

Also, in the first embodiment, the first cam pin 26 which constitutes the first cam mechanism 66 is provided on the side of the base plate 20, and the slide guide opening 42 of the slide plate 40 engages the first cam pin 26, so that the rotation and the movement in the Y-axis direction of the swing plate 30 and the sliding movement of the slide plate 40 can be interlocked.

Also, in the first embodiment, since the torsion spring 23 which applies an urging force in the −Y direction to the shaft portion 35 is provided, the reciprocating movement of the shaft portion 35 along the guide opening 25 can be achieved smoothly.

Also, in the first embodiment, since the projecting portion 37 which comes into contact with the −Z-side surface of the slide plate 40 is provided in the vicinity of the shaft portion 35 of the swing plate 30, even though a load about the X-axis direction is applied to the second housing 12 when the mobile phone set 100 is in the second state, the deformation in the direction of inclination can be restrained.

Also, in the first embodiment, since the first cam pin 26 stops at an end of the first cam groove 36, that is, at the terminal position and the second cam pin 28 stops at an end of the second cam groove 38, that is, at the terminal position as illustrated in FIG. 7D in the state in which the mobile phone set 100 is in the third state, a positional relationship between the first housing 11 and the second housing 12 in the third state can be accurately reproduced by the abutment between the respective cam pins 26, 28.

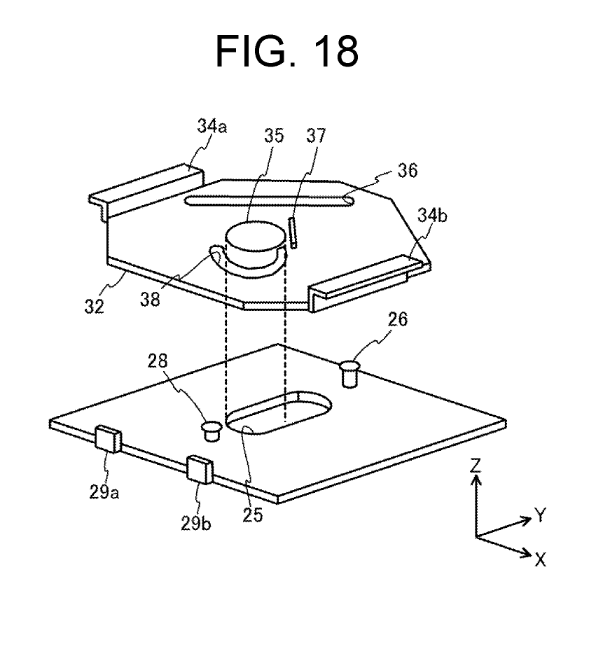

In the first embodiment described above, a pair of projecting portions 29a, 29b projecting in the Z-axis direction may be provided on a −Y-side end of the base plate 20 at a distance in the X-axis direction as illustrated in FIG. 18. The action or the like of the projecting portions 29a, 29b will be described below.

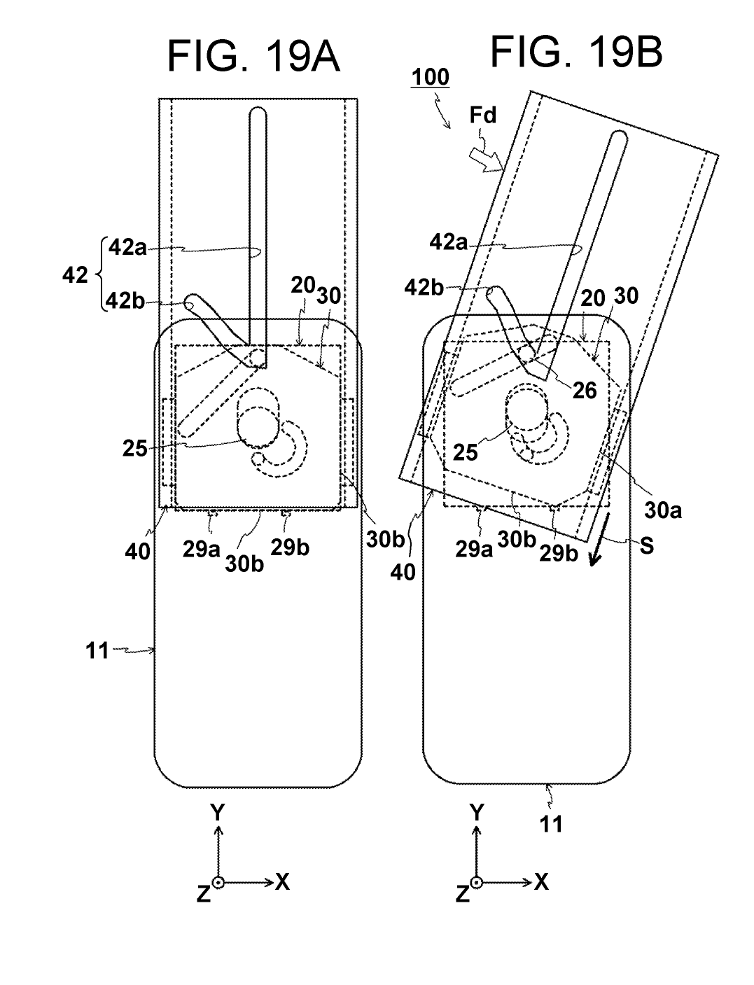

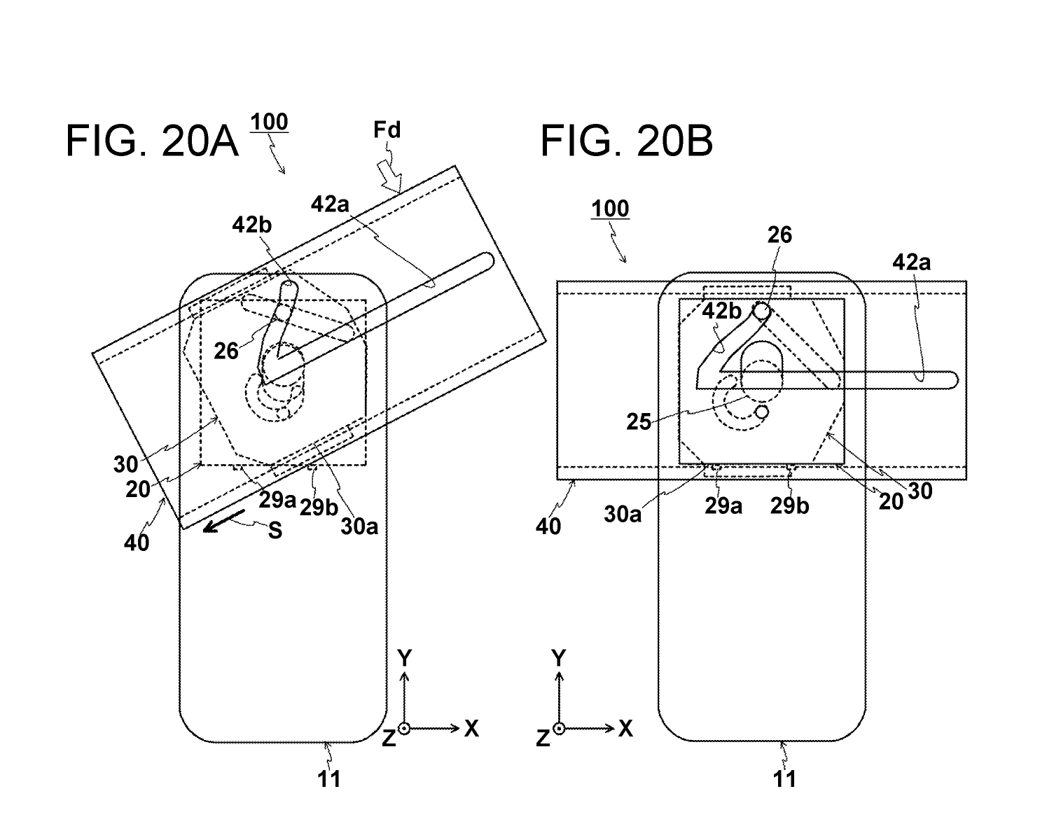

FIG. 19A illustrates a positional relationship between the pair of projecting portions 29a, 29b and surfaces 30a, 30b of the swing plate 30 when the mobile phone set 100 is in the second state. In the state illustrated in FIG. 19A, since the projecting portions 29a, 29b and the surface 30b are in contact with each other, the state illustrated in FIG. 19A is stably maintained. When the swing plate 30 is rotated from the state illustrated in FIG. 19A, the swing plate 30 slides in the +Y direction, and hence the contact does not occur between the swing plate 30 and the projecting portions 29a, 29b as illustrated in FIG. 19B. Also, as illustrated in FIG. 20A, even though the swing plate 30 is further rotated, the contact does not occur between the swing plate 30 and the projecting portions 29a, 29b. In contrast, when the swing plate 30 rotated by 90° as illustrated in FIG. 20B, the shaft portion 35 is returned to the same position as that illustrated in FIG. 19A, the projecting portions 29a, 29b and the side surface 30a of the swing plate 30 come into contact with each other. Therefore, in this example, a positional relationship between the slide plate 40 and the base plate 20 in the third state (the state illustrated in FIG. 20B) of the mobile phone set 100 can be maintained stably by the abutment of the side surface 30a with respect to the projecting portions 29a, 29b.

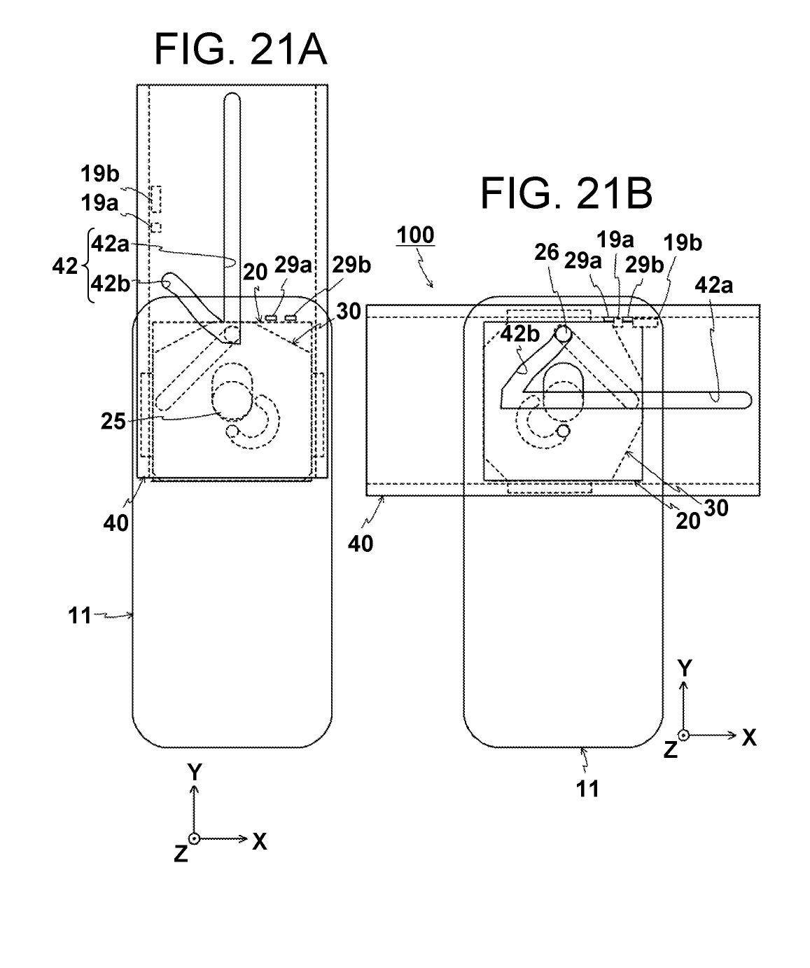

The projecting portions 29a, 29b do not have to be provided on the base plate 20. For example, as illustrated in FIG. 21A, the projecting portions 29a, 29b may be provided on the +Z surface of the first housing 11 in the vicinity of the +Y-side end. In this case, by the provision of projecting portions 19a, 19b on a −Z surface of the first housing 11 in the vicinity of an +X-side end, the projecting portion 19a is fitted between the projecting portions 29a, 29b and the projecting portion 29b is fitted between the projecting portions 19a, 19b in the state illustrated in FIG. 21B in which the second housing 12 is rotated by 90°. In this manner, even though the projecting portions 29a, 29b are arranged at different positions from FIG. 18 to FIG. 20B, the third state can be maintained stably.

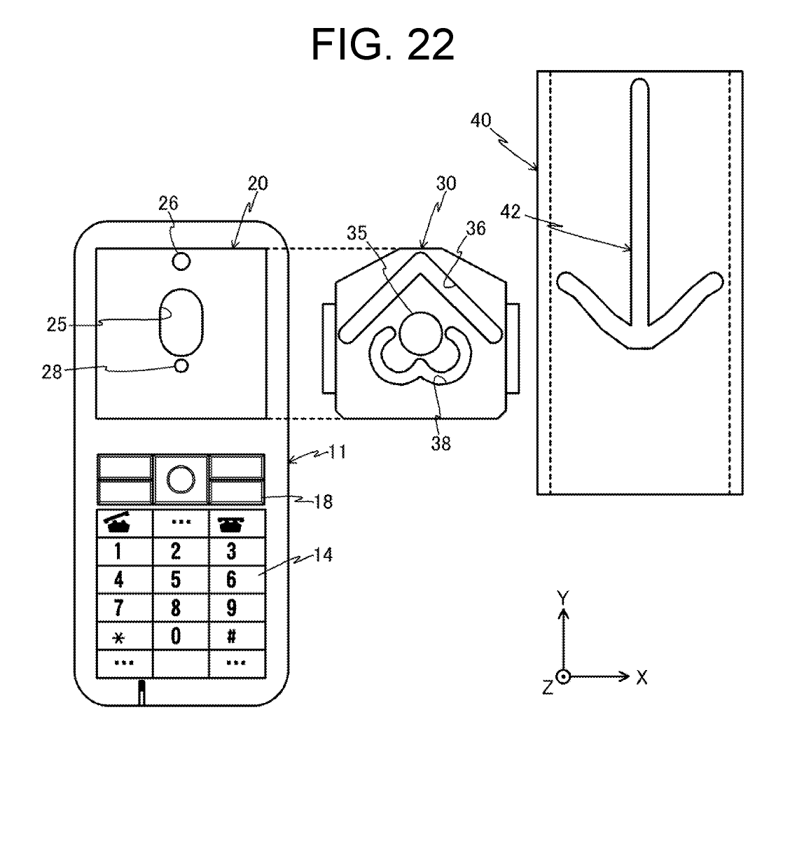

In the first embodiment described above, only the case where the second housing 12 rotates rightward (clockwise) when the state is changed from the second state to the third state has been described. However, the invention is not limited thereto. For example, a configuration in which the second housing 12 is rotated only leftward (counterclockwise) may be achieved by inverting the shapes and the arrangements of the first cam groove 36, the second cam groove 38, and the slide guide opening 42 in the lateral direction. Also, as illustrated in FIG. 22, a configuration in which the second housing 12 is rotated rightward (clockwise) and leftward (counterclockwise) may be achieved by changing the shapes of the first cam groove 36, the second cam groove 38, and the slide guide opening 42 into mirror symmetrical shapes.

In the first embodiment described above, only the case where the projecting portion 37 comes into contact with the −Z-side surface of the slide plate 40 has been described. However, the invention is not limited thereto. For example, in a case where the projecting portion 37 opposes the second housing 12 when the mobile phone set 100 is in the second state, the projecting portion 37 may be configured to come into contact with a −Z surface of the second housing 12. In this case as well, the same advantages as the embodiment described above are achieved.

### Second Embodiment

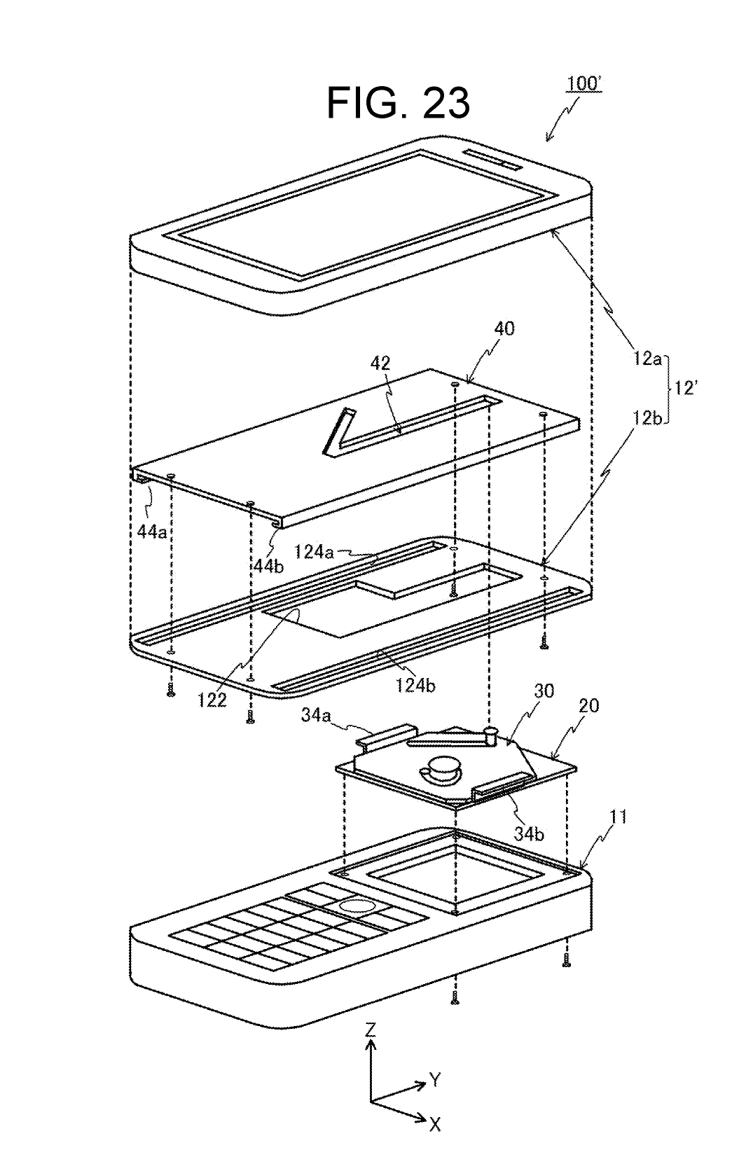

Subsequently, a second embodiment will be described with reference to FIG. 23 to FIG. 25E. The second embodiment is different in the structure of the second housing 12 and the method of assembling the slide plate 40 to the second housing 12.

FIG. 23 illustrates an exploded perspective view of a mobile phone set 100′ according to the second embodiment. As illustrated in FIG. 23, in the mobile phone set 100′, a second housing 12′ includes a body portion 12a and a bottom panel portion 12b, and the slide plate 40 is provided between the body portion 12a and the bottom panel portion 12b.

A space which can accommodate the slide plate 40 is formed on a −Z-side surface of the body portion 12a which constitutes the second housing 12′. The bottom panel portion 12b which constitutes the second housing 12′ is formed with a first through opening 122 of a substantially L-shape and a pair of second through openings 124a, 124b extending in the Y-axis direction. In a state in which the slide plate 40 is stored in the second housing 12′, a state in which the slide guide opening 42 of the slide plate 40 is positioned at a position of the first through opening 122, and the slide guides 44a, 44b of the slide plate 40 are inserted into the second through openings 124a, 124b is assumed respectively. In other words, the slide guide opening 42 and the slide guides 44a, 44b are accessible from the −Z side even in a state in which the slide plate 40 is stored in the interior of the second housing 12′.

When assembling the mobile phone set 100′ configured as described above, the slide plate 40 is fixed to the bottom panel portion 12b of the second housing 12′ with a screw and, in this state, the swing plate 30 and the base plate 20 assembled integrally is assembled with the slide plate 40. In other words, the sliding leg portions 34a, 34b of the swing plate 30 and the slide guides 44a, 44b of the slide plate 40 are engaged with each other. Then, the body portion 12a and the bottom panel portion 12b of the second housing 12′ are fixed with a screw or the like. Then, the base plate 20 is fixed to the first housing 11 with the screw or the like, so that the assembly of the mobile phone set 100′ is completed. Although it is not illustrated in FIG. 23, assembly of the spring mechanism 60 to a position between the slide plate 40 and the swing plate 30 is performed when assembling the slide plate 40.

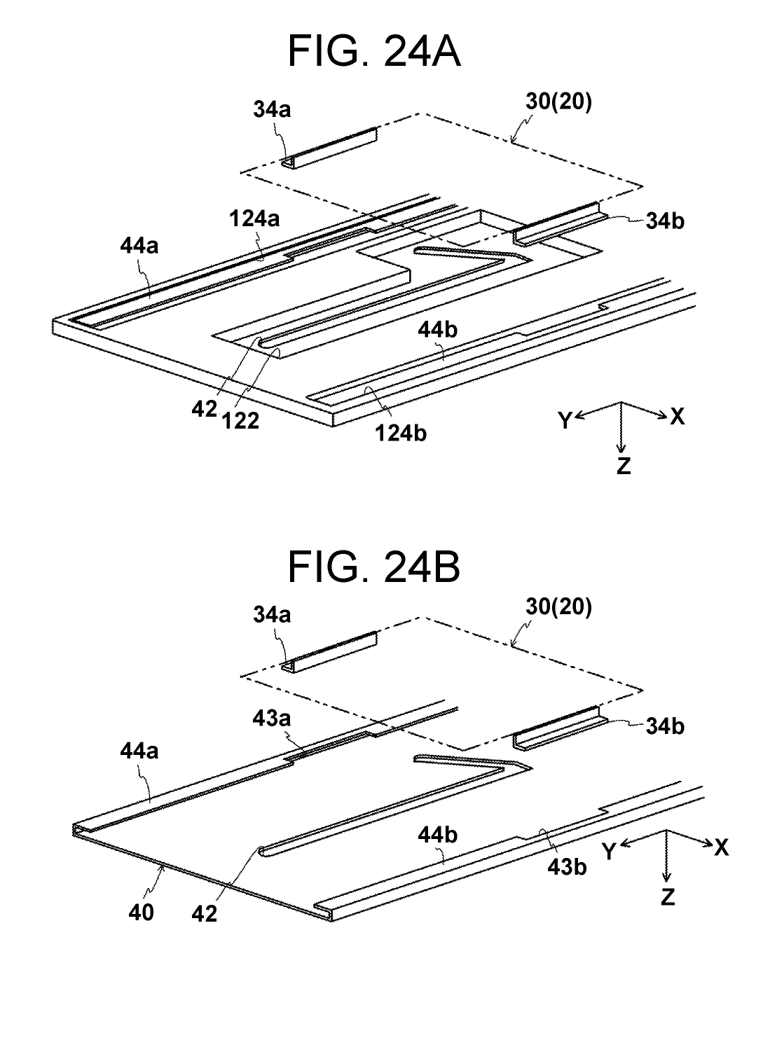

Incidentally, in the second embodiment, as is understood from the FIG. 24A (a perspective view illustrating the bottom panel portion 12b viewed from −Z side), the slide guides 44a, 44b of the slide plate 40 are positioned in the second through openings 124a, 124b. Therefore, when engaging the sliding leg portions 34a, 34b of the swing plate 30 with the slide guides 44a, 44b, it is difficult to insert the sliding leg portions 34a, 34b from +Y-side (or −Y-side) ends of the slide guides 44a, 44b.

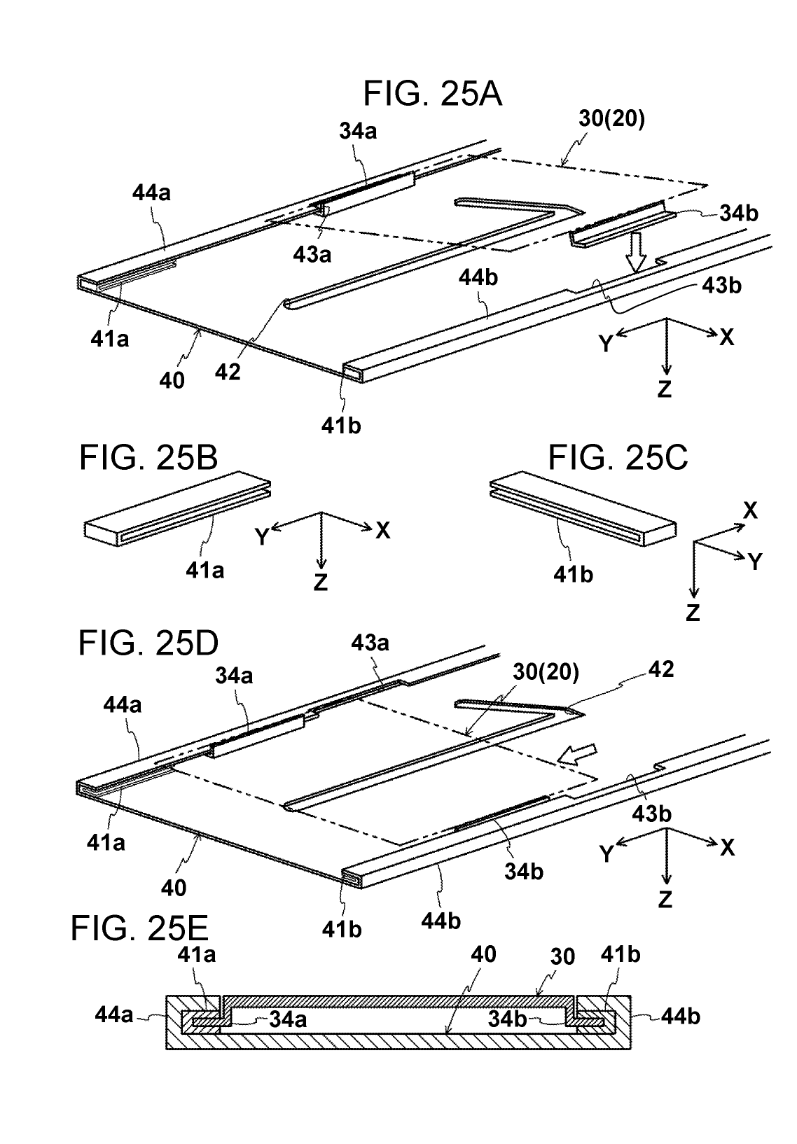

Therefore, in the second embodiment, as illustrated in FIG. 24B, the slide guides 44a, 44b are formed partly with notched portions 43a, 43b respectively, and the engagement of the sliding leg portions 34a, 34b with the slide guides 44a, 44b is performed as illustrated in FIG. 25A and FIG. 25B. In FIG. 25A and FIG. 25B, illustration of the bottom panel portion 12b is omitted for the convenience of illustration and description.

First of all, as illustrated in FIG. 25A, sliders (separation restraining members) 41a, 41b formed of silicon rubber or the like are inserted into the slide guides 44a, 44b from the notched portions 43a, 43b, and are placed at the +Y ends of the slide guides 44a, 44b. Here, the sliders 41a, 41b each have a substantially angular C-shape (U-shape) in cross section except for the end in the +Y direction as illustrated in FIG. 25B and FIG. 25C. In this state, as illustrated in FIG. 25A, the one sliding leg portion 34a is inserted into the notched portion 43a portion of the slide guide 44a obliquely from above, and the swing plate 30 (and the base plate 20) is rotated about the Y-axis with the sliding leg portion 34a as a fulcrum. Accordingly, the other sliding leg portion 34b is inserted into the slide guide 44b via the notched portion 43b.

In this manner, the swing plate 30 (and the base plate 20) are moved to a +Y-side end as illustrated in FIG. 25D in the state in which the sliding leg portions 34a, 34b are inserted into the slide guides 44a, 44b. In this configuration, the sliders 41a, 41b can be mounted on the sliding leg portions 34a, 34b. The state in which the sliders 41a, 41b are mounted in this manner is illustrated in FIG. 25E in cross section. As illustrated in FIG. 25E, the sliders 41a, 41b bridge the clearances between the sliding leg portions 34a, 34b and the slide guides 44a, 44b in a state being mounted on the sliding leg portions 34a, 34b to restrain separation of the sliding leg portions 34a, 34b from the slide guides 44a, 44b.

As described above, according to the second embodiment, the slide plate 40 is stored in the second housing 12′, and the slide plate 40 is exposed to the outside only partly such as the slide guide opening 42 even when the mobile phone set 100′ assumes the second state illustrated in FIG. 1B, the slide guides 44a, 44b and the portions in the vicinity thereof, improvement of the quality of the appearance of the mobile phone set 100′ is achieved. In this case, since a special process such as decoration does not have to be performed on the slide plate 40, reduction of the process steps and reduction of the manufacturing cost are achieved.

Also, since the notched portions 43a, 43b are provided on the slide guides 44a, 44b and the sliders 41a, 41b are mounted to the sliding leg portions 34a, 34b in the slide guides 44a, 44b, even though the configuration in which the slide plate 40 is stored in the second housing 12′ as in FIG. 24A is employed, assembly is achieved without problem.

### Third Embodiment

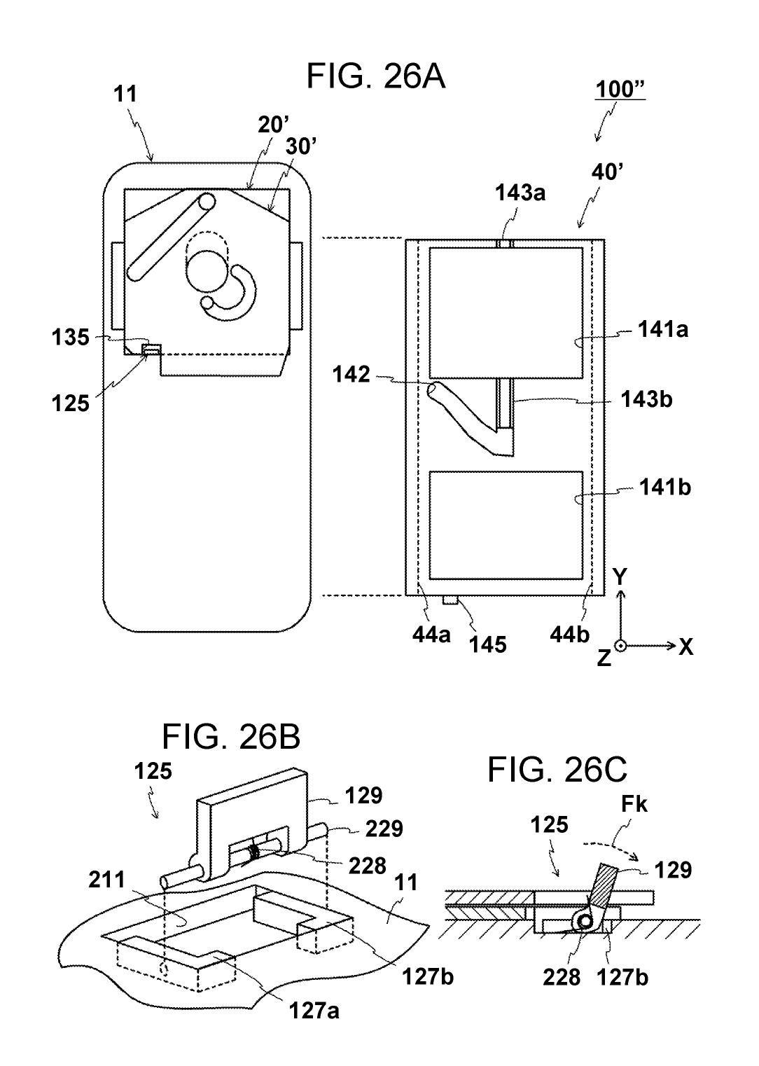

Subsequently, a third embodiment will be described with reference to FIG. 26A to FIG. 29B. The third embodiment is different from the first and second embodiments in the shape of the slide plate, and a rotation preventing mechanism 125 is provided.

FIG. 26A illustrates an exploded perspective view, partly omitted, of a mobile phone set 100″ according to the third embodiment. As illustrated in FIG. 26A, a slide plate 40′ of the mobile phone set 100″ is formed with two rectangular opening portions 141a, 141b and a slide guide opening 142. Also, a bent portion 143a formed in a state of a mountain fold on the +Z side is formed on a +Y-side portion of the opening portion 141a, and a bent portion 143b formed in a state of the mountain fold on the +Z side is formed between the opening portion 141a and the slide guide opening 142. The slide plate 40′ also has the slide guides 44a, 44b as in the first and second embodiments.

Also, a swing plate 30′ of the mobile phone set 100″ has a shape slightly different from the swing plate 30 in the first and second embodiments, and part of a −Y-side end (+X-side portion) thereof protrudes and a depressed portion 135 is formed in the vicinity of the protruded portion on the −X side.

Furthermore, a base plate 20′ of the mobile phone set 100″ is formed with the rotation preventing mechanism 125 as a locking mechanism. The rotation preventing mechanism 125 is provided in a rectangular depressed portion 211 formed actually on the first housing 11 so as to be depressed as illustrated in an exploded perspective view in FIG. 26B. The rotation preventing mechanism 125 includes substantially L-shaped stopper portions 127a, 127b provided in the rectangular depressed portion 211, a shaft portion 229 provided in a state of connecting the stopper portions 127a, 127b, a panel member 129 rotatably held with respect to the shaft portion 229, and a coil spring 228 provided on the shaft portion 229. The coil spring 228 constantly applies a rotating force Fk to the panel member 129 as illustrated in FIG. 26C which is a cross-sectional view of the rotation preventing mechanism 125. The stopper portions 127a, 127b come into contact with the panel member 129 to prevent the panel member 129 from tilting further than the state illustrated in FIG. 26C.

The slide plate 40′ is provided with a releasing member 145 as an unlocking mechanism configured to release the rotation preventing function of the rotation preventing mechanism 125 on a −Y-side end thereof as illustrated in FIG. 26A.

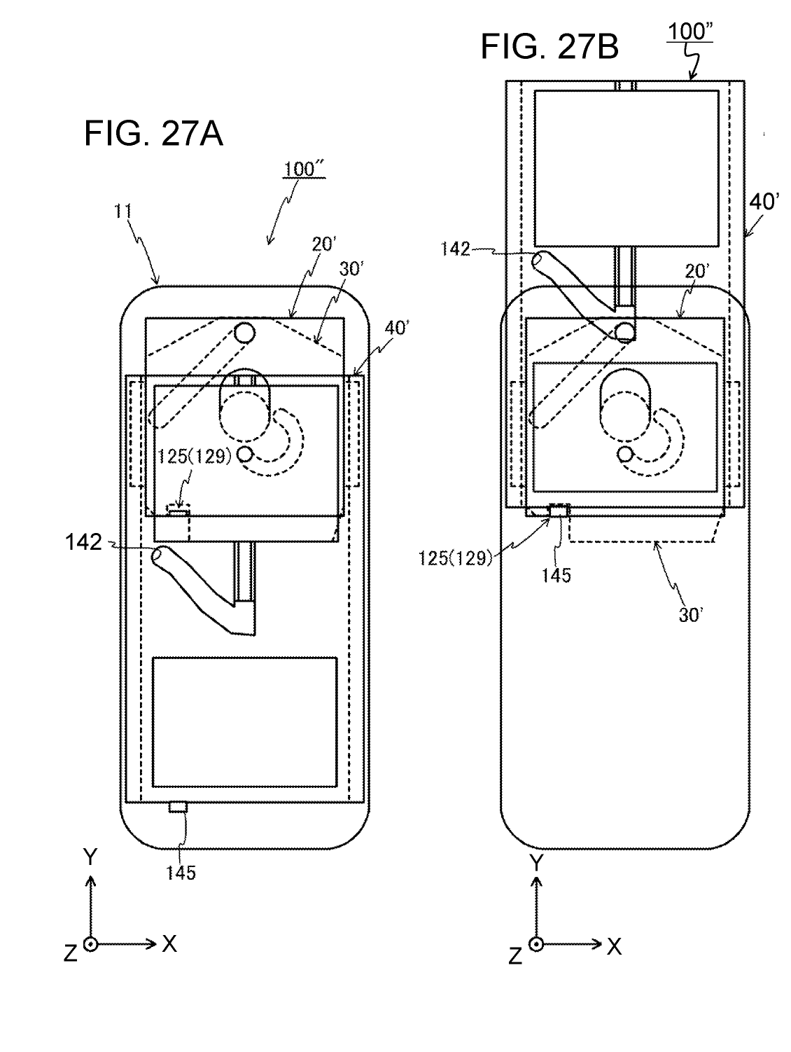

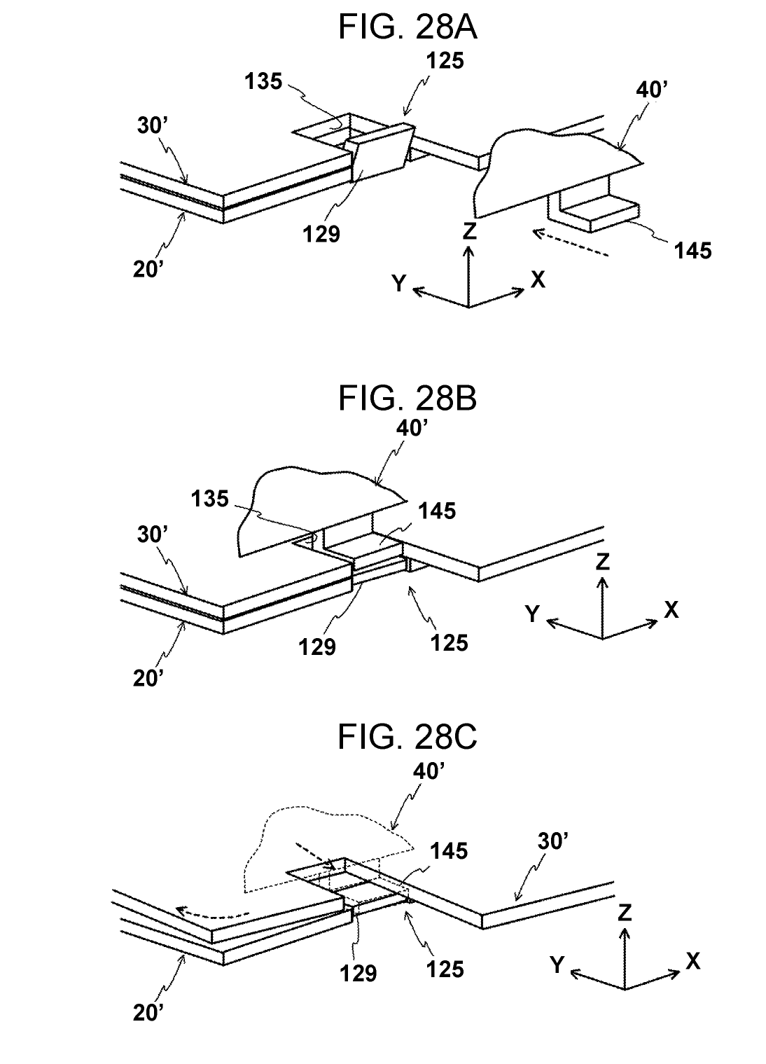

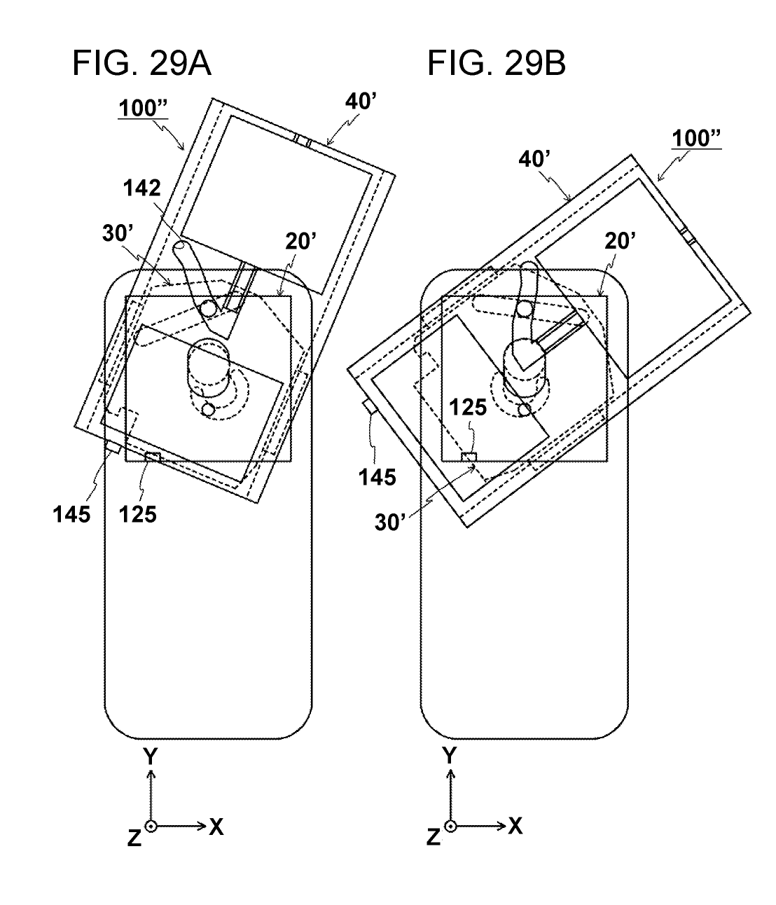

Subsequently, the action (movement) of the mobile phone set 100″ configured as described above will be described on the basis of FIG. 27A to FIG. 29B. In FIG. 27 and FIG. 29, the swing plate 30′ is illustrated in a broken line for the convenience of illustration. In FIGS. 28A to 28C, only the panel member 129 of the rotation preventing mechanism 125 is illustrated.

FIG. 27A illustrates a positional relationship between the rotation preventing mechanism 125 and the releasing member 145 in the first state, and FIG. 27B illustrates a positional relationship between the rotation preventing mechanism 125 and the releasing member 145 in the second state. As illustrated in these drawings, the rotation preventing mechanism 125 and the releasing member 145 do not come into contact with each other during the transient from the first state to the second state, that is, while the slide plate 40′ slides in the +Y direction. In this case, as illustrated in FIG. 28A, the panel member 129 of the rotation preventing mechanism 125 is in the raised position, the rotation of the swing plate 30′ is prevented by the panel member 129. In other words, the swing plate 30′ is not rotated while the slide plate 40′ is slid in the Y-axis direction even though the first opening portion 42a (for example, see FIG. 3A and so on) extending in the Y-axis direction is not provided on the slide plate 40′ as in the third embodiment.

In contrast, when the second state is assumed as illustrated in FIG. 27B, as illustrated in FIG. 28B, the releasing member 145 is seated pm the panel member 129 of the rotation preventing mechanism 125. In this state, since the panel member 129 is not raised as in FIG. 28A, the rotation preventing function of the rotation preventing mechanism 125 is brought into the unlocked state.

When a rotating force is applied to the slide plate 40′ as illustrated in FIG. 29A and FIG. 29B from this state, the swing plate 30′ rotates while being seated on the panel member 129 as illustrated in FIG. 28C. In this manner, in this embodiment, the rotation preventing function of the rotation preventing mechanism 125 is kept in the released state during the transient from the second state to the third state.

As described above, according to the third embodiment, the rotation of the swing plate 30′ is prevented by the rotation preventing mechanism 125 while the transient of the mobile phone set 100″ between the first state and the second state, and the rotation preventing function of the rotation preventing mechanism 125 is released and the rotation of the swing plate 30 is allowed during the transient between the second state and the third state. Therefore, the similar movement as in the first and second embodiments is realized without providing the slide guide opening extending in the Y-axis direction on the slide plate 40′. In this case, since the opening portions 141a, 141b can be provided as illustrated in FIG. 26A, the width of the slide plate 40′ can be reduced. In the third embodiment, since the slide guide opening extending in the Y-axis direction as in the first and second embodiments is not provided, the appearance is improved in comparison with the case where the guide opening is exposed in appearance.

In the third embodiment described above, the case where the shape of the swing plate 30′ is differentiated from the shape of the swing plate 30 in the first and second embodiments so as to make the swing plate 30′ to be kept in the state of being seated on the panel member 129 of the rotation preventing mechanism 125 while the swing plate 30′ is rotated has been described. However, the invention is not limited thereto, and the swing plate having the same shape as the first and second embodiments may be employed as long as the swing plate 30′ is kept in the state of being seated on the panel member 129 of the rotation preventing mechanism 125 while the swing plate 30′ is rotated.

Also, although the case where the rotation preventing mechanism 125 is provided on the base plate 20′ has been described in the third embodiment described above, the invention is not limited thereto, and the rotation preventing mechanism 125 may be provided on the first housing 11. Also, although the case where the releasing member 145 is provided on the slide plate 40 has been described in the third embodiment described above, the invention is not limited thereto, and the releasing member 145 may be provided on the second housing 12.

Also, the rotation preventing mechanism 125 and the releasing member 145 are not limited to the configuration as described above, and other configurations may be employed as long as the rotation of the swing plate is selectively prevented or allowed in conjunction with the movements of the first housing 11 and the second housing 12.

### Fourth Embodiment

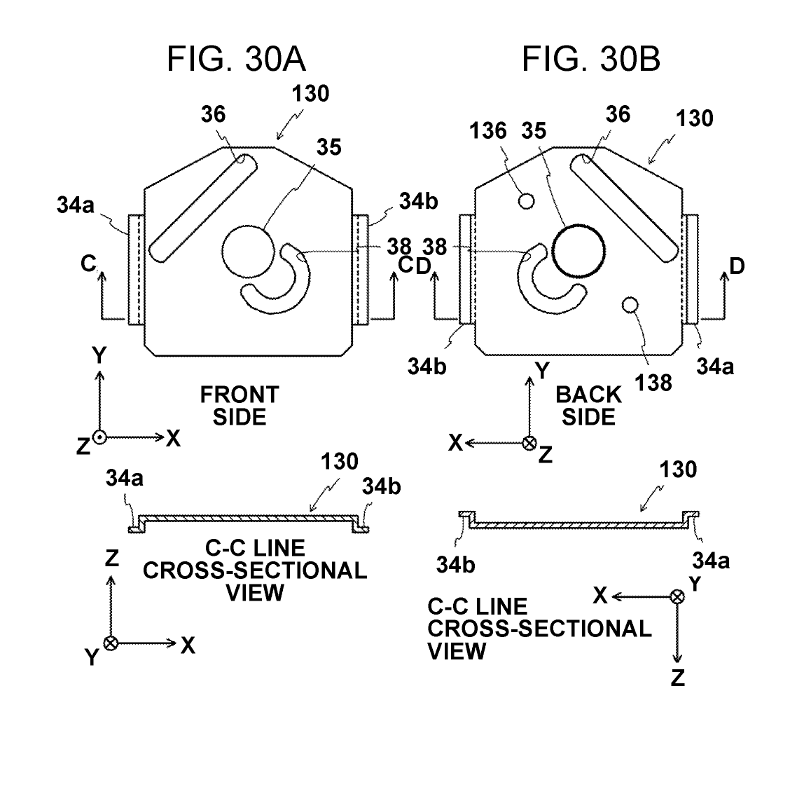

Subsequently, a fourth embodiment will be described with reference to FIG. 30A to FIG. 32C. The fourth embodiment is different from the first and second embodiments in the configuration of the base plate and the swing plate.

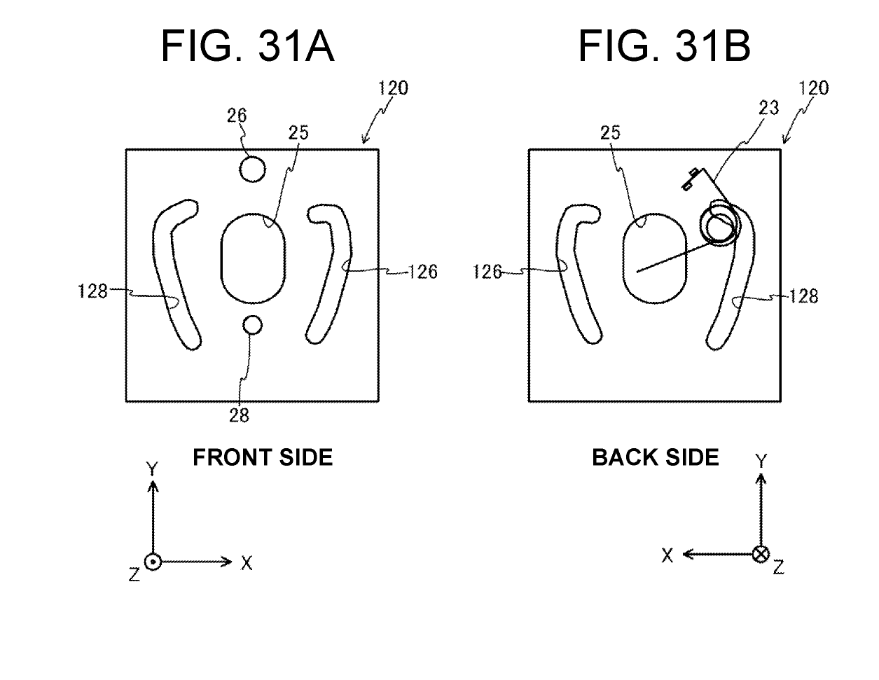

FIG. 30A is a drawing of a swing plate 130 in the fourth embodiment when viewed from the +Z side (front side), and FIG. 30B is a drawing of the swing plate 130 viewed from the −Z side (back side). FIG. 31A is a drawing of the base plate 120 in the fourth embodiment when viewed from the +Z side (front side), and FIG. 31B is a drawing of the base plate 120 viewed from the −Z side (back side).

As is understood from FIG. 30A and FIG. 30B, the swing plate 130 has the same configuration as the swing plate 30 in the first and second embodiments on the front side, but is different from the swing plate 30 in the first and second embodiments in that a first pin 136 and a second pin 138 are provided so as to project from the back side.

Also, a base plate 120 is different from the base plate 20 in the first and second embodiments in that a first engaging groove 126 extending in the substantially Y-axis direction is formed on the +X side of the guide opening 25 and a second engaging groove 128 extending in the substantially Y-axis direction is formed on the −X side of the guide opening 25 as illustrated in FIG. 31A and FIG. 31B.

When the swing plate 130 and the base plate 120 are assembled, the first pin 136 is inserted into the first engaging groove 126, and the second pin 138 is inserted into the second engaging groove 128. In this manner, when clips are fixed to distal ends of the first pin 136 and the second pin 138 in a state in which the swing plate 130 and the base plate 120 are assembled, separation of the swing plate 130 from the base plate 120 is prevented by these clips.

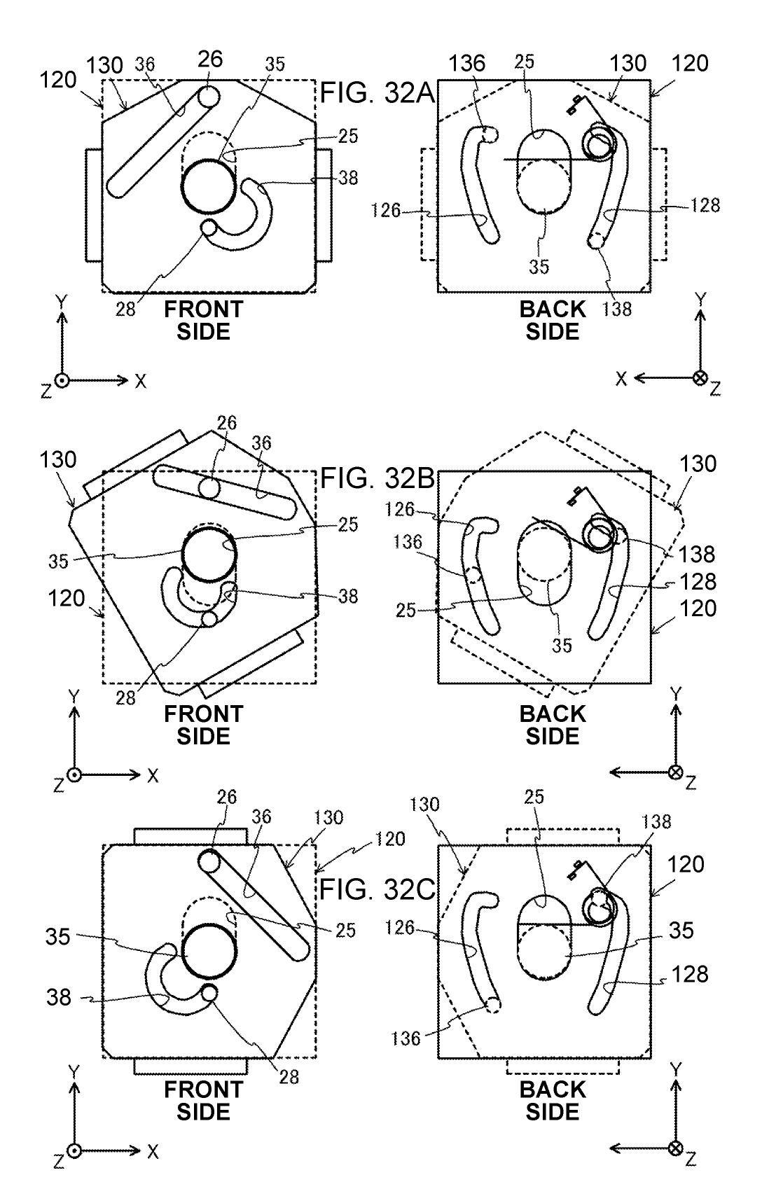

FIGS. 32A to 32C illustrates a state while the swing plate 130 is rotated with respect to the base plate 120. In the respective drawings in FIGS. 32A to 32C, the drawings on the left side illustrate states in which the swing plate 130 is viewed from the +Z side and the drawings on the right side illustrate states in which the base plate 120 is viewed from the −Z side.

As illustrated in FIG. 32A to FIG. 32C, when the swing plate 130 is rotated, the same action as in the first and second embodiments is performed when the state of rotation is viewed from the +Z side (when referring to the drawings on the left side in the respective drawings). In contrast, when the state of rotation is viewed from the −Z side (when referring to the drawings on the right side of the respective drawings), the first pin 136 moves along the first engaging groove 126, and the second pin 138 moves along the second engaging groove 128. In this manner, in this embodiment, the first pin 136 and the second pin 138 do not hinder the rotation of the swing plate 130 while the swing plate 130 is rotated.

As described above, according to the fourth embodiment, the same advantages as the first and second embodiments are achieved and, in addition, assembly between the swing plate 130 and the base plate 120 may be strengthened by the engagement between the first pin 136 and the first engaging groove 126, and the engagement between the second pin 138 and the second engaging groove 128. Accordingly, the contribution to the elongation of the life time of the mobile phone set is achieved.

In the embodiment described above, the two pins 136, 138 are provided on the swing plate 130, and the engaging grooves 126, 128 by the number corresponding thereto are provided on the base plate 120. However, the invention is not limited thereto, and the number of the pins may be any number within a range in which the interference between the engaging grooves is avoided. Also, in the embodiment described above, the case in which the pins are provided on the swing plate 130, and the engaging grooves are formed on the base plate 120 has been described. However, the invention is not limited thereto, and a configuration in which the pins are provided on the base plate 120 and the engaging grooves are provided on the swing plate 130 is also applicable as long as the engaging grooves do not interfere with the first and second cam grooves 36, 38.

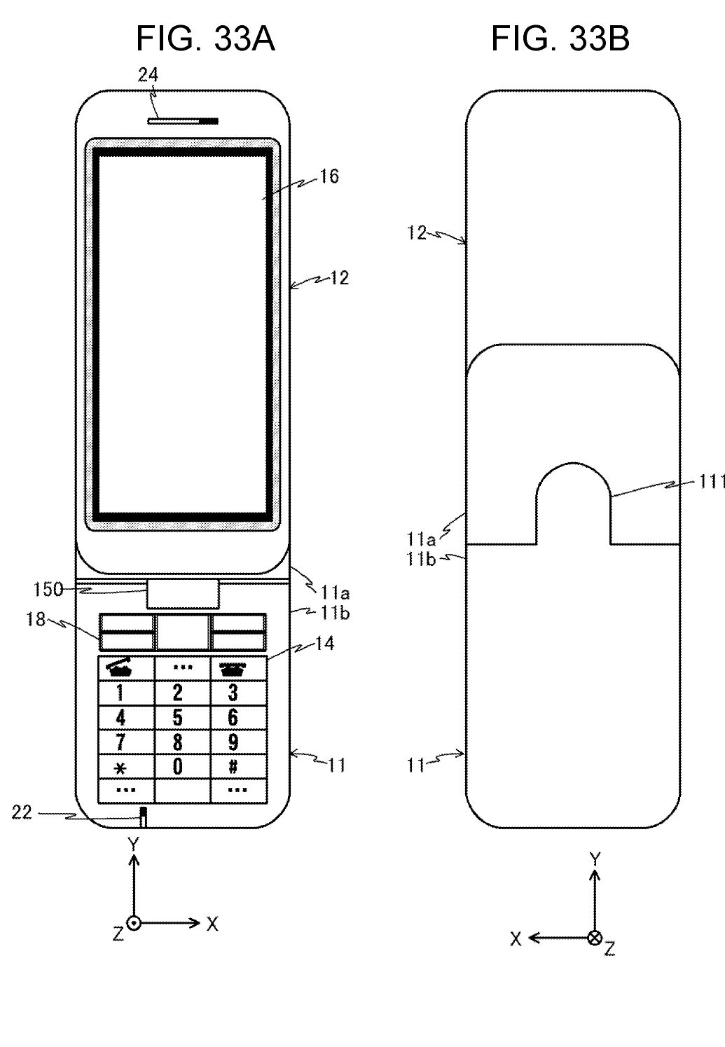

Although the case where the first housing 11 of the mobile phone set is an integrated member has been described in the embodiments described above, the invention is not limited thereto and, for example, a configuration in which the first housing 11 includes two partial housings 11a, 11b and the respective partial housings 11a, 11b are connected with a hinge 150 may also be applicable as illustrated in FIG. 33 A. In this case, a projecting portion 111 having a shape as illustrated in FIG. 33B may be provided on the back surface side (−Z side) of the partial housing 11b.

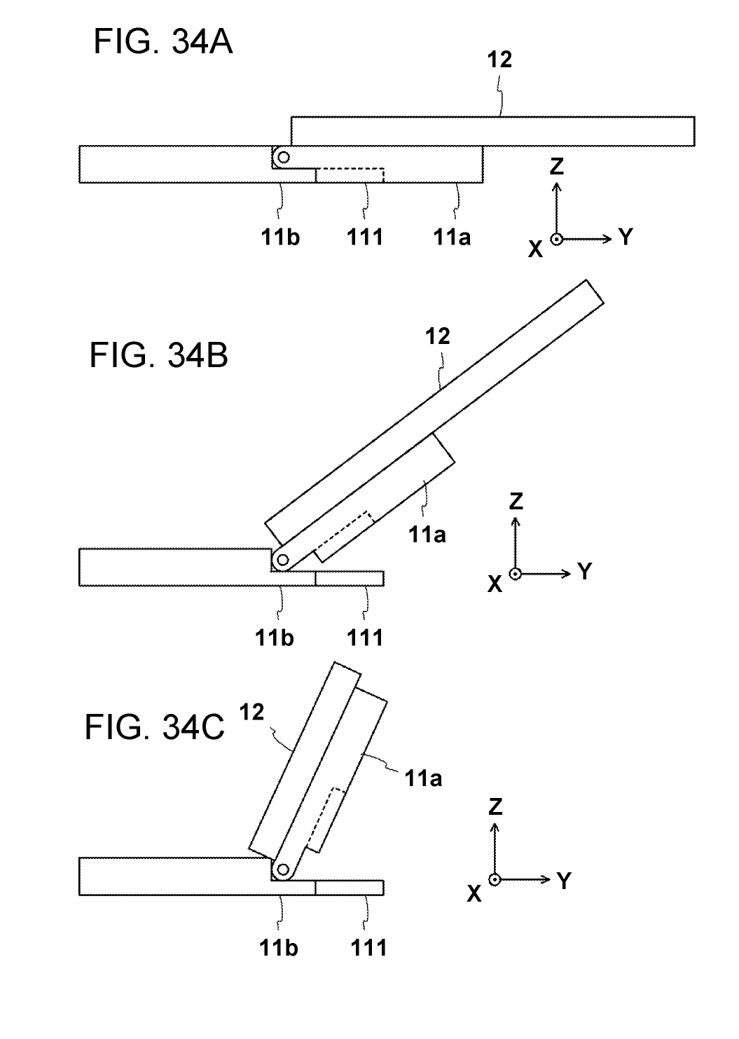

By employing the configuration as described above, when the angle of the partial housings 11a, 11b of the mobile phone set is changed from the second state illustrated in FIG. 34A, a state as illustrated in FIG. 34B is assumed, and when the second housing 12 is rotated from the state illustrated in FIG. 34B, a state as illustrated in FIG. 34C is assumed. As is understood from these drawings, since the projecting portion 111 is provided on the side of the partial housing 11b in this example, the mobile phone set is restrained from tipping over when it is bent and placed on the table or the like. In this case, since a member for tip-resistant member is not additionally provided, there is almost no deterioration of the appearance quality.

The tipping moment of the mobile phone set is determined by the position of the center of gravity and the weight of the apparatus, the length of the projecting portion 111 in the Y-axis direction is determined on the basis of the position of the center of gravity and the weight.

In the respective embodiments described above, the arrangement of the pins and the shape of the grooves are described as an example only, and the arrangement of the pins or the shape of the grooves may be changed variously as needed. For example, although the first cam groove 36 is formed into a substantially linear shape in the respective embodiments described above, it may be formed into an arcuate shape instead.

Although the case where the information terminal apparatus is applied to the mobile phone set has been described in the respective embodiments described above, the invention is not limited thereto, and it may be applied to PHS or PDA as a matter of course, and also to other information terminal apparatuses.

Although the case in which the hinge unit is applied to the mobile phone set has been described in the respective embodiments described above, the invention is not limited thereto, and it may be applied to the information terminal apparatus other than the mobile phone set as a matter of course, and also to other apparatuses (apparatuses which performs a sliding motion and a rotating motion).

The information terminal apparatus described in this specification provides an advantage such that improvement of operability is achieved. The hinge unit described in this specification provides an advantage such that contribution to the improvement of operability of the information terminal apparatus or the like is achieved.

The embodiments described above are preferred examples of the present invention. However, the invention is not limited thereto, and may be modified variously without departing the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A information terminal apparatus comprising:
a cam mechanism that includes a cam pin and a cam groove engaged with the cam pin;
a base plate;
a swing plate being rotatable with respect to the base plate by the cam mechanism; and
a first elastic piece that applies a first force to at least one of the base plate and the swing plate, the first force causing the cam pin to move to a edge of the cam groove, in a case that the cam pin is located at between the edge and a specific point, which is located at between the edge and an opposite edge in the cam groove, and causing the cam pin to move to the opposite edge, in a case that the cam pin is located at between the certain point and the opposite edge; and
a second elastic piece that applies a second force, which makes the cam pin moved to the edge, to the at least one of the base plate and the swing plate.

2. The information terminal apparatus according to claim 1, wherein
the first force and the second force are not applied, in a case that the cam pin is located at one of the edge and the opposite edge.

3. The information terminal apparatus according to claim 1, wherein
the cam mechanism includes a plurality set of a cam pin and a cam groove.

4. The information terminal apparatus according to claim 1, further comprising:
a first housing loaded with the base plate;
a slide plate slidably engaging with the swing plate; and
a second housing fixed on the slide plate.

5. The information terminal apparatus according to claim 4, wherein
in the case of the cam pin being located at the edge, the information terminal apparatus allow to call as a phone.

6. The information terminal apparatus according to claim 4, wherein
the second elastic piece applies the second force to at least one of the swing plate and the slide plate, while the slide plate slides with respect to the swing plate.

7. The information terminal apparatus according to claim 4, further comprising:
a guide portion provided on the slide plate for restricting movement of the slide plate, wherein the cam groove is provided on the swing plate, and the cam pin is provided on the base plate, the cam pin further engaging with the guide portion.

8. The information terminal apparatus according to claim 4, further comprising a projecting portion provided on the swing plate, the projecting portion being capable of contacting to at least one of the slide plate and the second housing.

9. The information terminal apparatus according to claim 4, further comprising;
a display unit fixed on the second housing; and
a input operation unit fixed on the first housing; wherein the slide plate has a portion with which at least one of the swing plate and the base plate engages, the portion being exposed to the opposite surface of the second housing.

10. The information terminal apparatus according to claim 4 further comprising:
a pair of slide guides provided on the slide plate, each slide guide extending a direction in which the each slide plate slides;
a pair of sliding legs provided on the swing plate, each sliding leg respectively engaging with one of the slide guides
clearances respectively provided between the sliding legs and the slide guides; and
bridge members respectively provided between the sliding legs and the slide guides so as to restrain separation of the sliding legs from the slide guides.

11. The information terminal apparatus according to claim 4, further comprising:
a lock mechanism including a projecting portion, provided on at least one of the base plate and the first housing, for restricting the swing plate from rotating, the projecting portion being capable of projecting toward a side of the swing plate; and
a releasing member provided on at least one of the slide plate and the second housing, the releasing member being capable of coming into contact with the lock mechanism in accordance with the position of the slide plate with respect to the base plate so as to reduce the amount of the projection of the projecting portion to cancel the lock mechanism.
